(19) United States
(12) Patent Application Publication
(10) Pub. No.: US 2026/0297350 A1
(43) Pub. Date: Oct. 1, 2026

(54) AQUEOUS INK FOR INKJET RECORDING

(71) Applicant: KYOCERA DOCUMENT SOLUTIONS INC., OSAKA (JP)

(72) Inventors: KATSUKI OSANISHI, OSAKA (JP); KOTATSU KAWAGUCHI, OSAKA (JP); HIROKA ITANI, OSAKA (JP); KENTARO OKINAKA, OSAKA (JP); MOTOKI SUZUKI, OSAKA (JP); SHUN KANDA, OSAKA (JP); YUSUKE WASHINO, OSAKA (JP)

(21) Appl. No.: 19/461,738

(22) Filed: Jan. 28, 2026

(30) Foreign Application Priority Data
Feb. 4, 2025 (JP) 2025-016806
May 2, 2025 (JP) 2025-076658
May 2, 2025 (JP) 2025-076659
May 2, 2025 (JP) 2025-076660

(51) Int. Cl. C09D 11/326; C09D 11/38

(52) U.S. Cl. CPC C09D 11/326; C09D 11/38

(57) ABSTRACT

An aqueous ink for inkjet recording includes a pigment, a polyethylene glycol having an average molecular weight of 150 or more and 650 or less in an amount of 7 mass % or more and 20 mass % or less, at least one of the group consisting of triethylene glycol monobutyl ether, 1,2-hexanediol, 1,2-octanediol, 2-methyl-2,4-pentanediol, dipropylene glycol monomethyl ether, and tripropylene glycol monomethyl ether in an amount of 1 mass % or more and 10 mass % or less, a water-soluble organic additive that is solid at 25° C. in an amount of 3 mass % or more and 15.0 mass % or less, and water.

### CROSS-REFERENCE TO RELATED PATENT APPLICATION

This application claims the benefit of Japanese Priority Patent Application JP 2025-016806 filed on Feb. 4, 2025, and Japanese Application Nos. 2025-076658, 2025-076659, and 2025-076660 filed on May 2, 2025, the entire contents of which are incorporated herein by reference.

### FIELD OF THE DISCLOSURE

The present disclosure relates to an aqueous ink for inkjet recording.

### BACKGROUND OF THE DISCLOSURE

An inkjet recording apparatus forms an image on a recording medium by repeatedly ejecting small droplets of an ink from a nozzle onto the recording medium such as paper. The recording medium configured of fibers, such as paper, causes a phenomenon where the medium warps (curling) due to partial fiber expansion and contraction caused by forming the image with the ink. To suppress the occurrence of curling, a known technology involves blending polyethylene glycol into the ink.

### SUMMARY OF THE DISCLOSURE

An aqueous ink for inkjet recording according to an embodiment of the present disclosure includes a pigment, a polyethylene glycol having an average molecular weight of 150 or more and 650 or less in an amount of 7 mass % or more and 20 mass % or less, at least one of the group consisting of triethylene glycol monobutyl ether, 1,2-hexanediol, 1,2-octanediol, 2-methyl-2,4-pentanediol, dipropylene glycol monomethyl ether, and tripropylene glycol monomethyl ether in an amount of 1 mass % or more and 10 mass % or less, an additive that is solid at 25° C. in an amount of 3 mass % or more and 15 mass % or less, and water.

### DETAILED DESCRIPTION OF THE EXEMPLARY EMBODIMENTS

An ink into which polyethylene glycol is blended tends to become incapable of being ejected due to drying within a nozzle of a recording head as viscosity increases, making it difficult to ensure an intermittent ejection performance. Furthermore, the ink into which polyethylene glycol is blended tends to produce an image with low density on a recording medium, and also readily adheres to an exit roller of an inkjet recording apparatus, causing a phenomenon that contaminates a subsequent recording medium via the exit roller (offset). Additionally, such ink makes it difficult to achieve both an image density and redispersibility.

In light of the above circumstances, an object of the present disclosure is to provide an aqueous ink for inkjet recording that can ensure an intermittent ejection performance, an image density, and redispersibility, while also suppressing offset and curling occurrences.

Embodiments of the present disclosure will be described below.

### Aqueous Ink for Inkjet Recording

### General Description

An aqueous ink for inkjet recording according to an embodiment of the present disclosure (hereinafter also referred to simply as “ink”) includes a pigment a, a wetting agent b, a permeating agent c, a solid additive d, and water. The wetting agent b is configured of a polyethylene glycol having a number average molecular weight of 150 or more and 650 or less. The permeating agent c is configured of at least one selected from the group consisting of triethylene glycol monobutyl ether, 1,2-hexanediol, 1,2-octanediol, 2-methyl-2,4-pentanediol, dipropylene glycol monomethyl ether, and tripropylene glycol monomethyl ether. The solid additive d is a water-soluble organic additive that is solid at 25° C.

The ink according to this embodiment is typically an aqueous ink ejected from a recording head of an inkjet recording apparatus onto a recording medium to form an image on the recording medium. The recording medium on which the image is formed by the ink according to this embodiment is configured of fibers such as cellulose fibers and includes, for example, plain paper, copy paper, recycled paper, thin paper, and thick paper.

In the ink according to this embodiment, an action of the wetting agent b suppresses a curling occurrence and also a pigment agglomeration due to high hydrophilicity, which results in high redispersibility. In the ink according to this embodiment, to effectively achieve the action of the wetting agent b, a content of the wetting agent b is 7 mass % or more. On the other hand, in the ink according to this embodiment, to prevent an offset occurrence, an excessive amount of the wetting agent b is undesirable. Therefore, in the ink according to this embodiment, a content of the wetting agent b is 20 mass % or less.

Furthermore, in the ink according to this embodiment, an action of the permeating agent c increases permeability of the ink into the recording medium, thereby suppressing the offset occurrence. In the ink according to this embodiment, to effectively obtain this action from the permeating agent c, a content of the permeating agent c is 1 mass % or more. On the other hand, in the ink according to this embodiment, an excessive amount of permeating agent c is undesirable to obtain high redispersibility. Therefore, in the ink according to this embodiment, the content of the permeating agent c is 10 mass % or less.

Furthermore, the ink according to this embodiment improves scratch resistance due to an action of the solid additive d, thereby suppressing the offset occurrence. To effectively achieve this action of the solid additive d, in the ink according to this embodiment, a content of the solid additive d is 3 mass % or more. On the other hand, to obtain a good intermittent ejection performance in the ink according to this embodiment, it is undesirable for the content of the solid additive d to be too high. Therefore, in the ink according to this embodiment, the content of the solid additive d is 15 mass % or less.

### (Pigment a)

As the pigment a, a self-dispersing pigment or a resin-dispersed pigment is used.

### Self-Dispersing Pigment

The self-dispersing pigment blended into the ink according to this embodiment is a pigment to which a hydrophilic group is directly or indirectly bonded to a surface via a physical surface treatment or a chemical surface treatment. The self-dispersing pigment imparts a desired image density to an image to be formed.

The hydrophilic group on a particle surface of the self-dispersing pigment is not particularly limited, but examples include one or more of hydrophilic groups represented by a chemical formula selected from the group consisting of —OM, —COOM, —CO—, —SO₃M, —SO₂M, —SO₂NH₂, —RSO₂M, —PO₃HM, —PO₃M₂, —SO₂NHCOR, —NH₃, and —NR₃. In each chemical formula, M represents a hydrogen atom, an alkali metal, ammonium, a phenyl group which may be substituted with a substituent, or an organic ammonium. R represents an alkyl group having 1 to 12 carbon atoms, or an aryl group having 1 to 12 carbon atoms which may be substituted with a substituent. The aryl groups include a phenyl group and a naphthyl group.

Among these, an anionic functional group is preferred as the hydrophilic group. That is, as the self-dispersing pigment, an anionic self-dispersing pigment having the anionic functional group on its surface is preferred. The anionic functional group is not particularly limited to any specific group, provided it is negatively charged in an aqueous medium; examples include a carboxyl group, a sulfonic acid group, a phosphonic acid group, and a phosphoric acid group. The anionic functional group may also form a salt (e.g., ammonium salt and metal salt) with a cation.

The self-dispersing pigment can be prepared by applying a known physical surface treatment or chemical surface treatment to a pigment having no self-dispersibility. Examples of the physical surface treatment include a vacuum plasma treatment. Examples of the chemical surface treatment include, for example, a wet oxidation treatment using an oxidizing agent in water, and a treatment to bond p-aminobenzoic acid to a pigment surface (in this treatment, a carboxyl group is bonded to the pigment surface via a phenyl group).

A commercially available product may also be used as the self-dispersing pigment. Examples of such commercially available product include the CAB-O-Jet (registered trademark) series (e.g., CAB-O-Jet (registered trademark) 200, 300, 400, 250C, 260M, 270Y, 450C, 465M, 470Y, and 480M) manufactured by Cabot Corporation, IJX series (e.g., IJX-157, 253, 266, 273, 444, and 55) manufactured by Cabot Corporation, BONJET (registered trademark) series (e.g., BONJET (registered trademark) CW-1, BONJET (registered trademark) CW-1S, CW-2, and CW-3) manufactured by Orient Chemical Industry Co., Ltd., and the Aqua-Black (registered trademark) series (e.g., Aqua-Black (registered trademark) 001 and 162) manufactured by Tokai Carbon Co., Ltd.

A pigment used as raw materials for the self-dispersing pigment (pigment having no self-dispersibility) includes, for example, a yellow pigment, an orange pigment, a red pigment, a blue pigment, a purple pigment, and a black pigment. Examples of the yellow pigment include C.I. Pigment Yellow (1, 2, 3, 12, 13, 14, 16, 17, 55, 73, 74, 75, 83, 93, 95, 97, 98, 109, 110, 114, 120, 128, 129, 138, 139, 150, 151, 154, 155, 173, 180, 185, and 193). Examples of the orange pigment include, for example, C.I. Pigment Orange (34, 36, 43, 61, 63, and 71). Examples of the red pigment include C.I. Pigment Red (5, 7, 12, 48, 48 (more specifically 48:1), 57, 112, 122, 123, 146, 168, 184, and 202). Examples of the blue pigment includes C.I. Pigment Blue (1, 2, 3, 15 (more specifically 15:3 and 15:4), 16, 22, and 60). Examples of the violet pigment include C.I. Pigment Violet (19, 23, 33, and 1960). Examples of the black pigment include No. 2300, No. 900, MCF88, No. 33, No. 40, No. 45, No. 52, MA7, MA8, MA100, and No. 2200B manufactured by Mitsubishi Chemical Corporation, Raven (registered trademark) (5750, 5250, 5000, 3500, 1255, and 700) manufactured by Columbia Chemical Co., Ltd, conductive carbon black such as Regal (registered trademark) (400R, 330R, and 660R), Mogul (registered trademark) L, Monarch (registered trademark) (700, 800, 880, 900, 1000, 1100, 1300, and 1400), and BLACK PEARLS (registered trademark) 2000, VULCAN (registered trademark) XC-72, VULCAN (registered trademark) P, and STERLIB (registered trademark) C manufactured by Cabot Corporation, and carbon black such as Color Black (FW1, FW2, FW2V, FW18, FW200, S150, S160, and S170), Printex (registered trademark) (35, U, V, and 140U), and Special Black (4, 4A, 5, and 6) manufactured by Orion engineered Corporation.

In the ink according to this embodiment, a content of the self-dispersing pigment is preferably 4 mass % or more and 12 mass % or less, and more preferably 5 mass % or more and 10 mass % or less. In the ink according to this embodiment, setting the content of the self-dispersing pigment to 4 mass % or more facilitates obtaining an image having a desired image density. In the ink according to this embodiment, setting the content of the self-dispersing pigment to 12 mass % or less facilitates ensuring fluidity of the self-dispersing pigment, thereby making it easier to obtain the desired image density.

### Resin-Dispersed Pigment

The pigment a blended into the ink according to this embodiment may be a resin-dispersed pigment that forms a pigment dispersion together with a pigment dispersion resin, which is a dispersant adhering to its surface. The pigment dispersion achieves good dispersibility in an aqueous medium due to an action of the pigment dispersion resin. The pigment a configuring the pigment dispersion may be a pigment to which the surface treatment is not applied or the self-dispersing pigment to which the surface treatment is applied.

As the pigment a configuring the resin dispersion, for example, the yellow pigment, the orange pigment, the red pigment, the blue pigment, the purple pigment, or the black pigment can be used. Examples of the yellow pigment include C.I. Pigment Yellow 74, 93, 95, 109, 110, 120, 128, 138, 139, 151, 154, 155, 173, 180, 185, or 193. Examples of the orange pigment include, for example, C.I. Pigment Orange 34, 36, 43, 61, 63, or 71. Examples of the red pigment include, for example, C.I. Pigment Red 122 or 202. Examples of the blue pigment include C.I. Pigment Blue 15 or 15:3. Examples of the violet pigment include C.I. Pigment Violet 19, 23, or 33. Examples of the black pigment include C.I. Pigment Black 7.

In the ink according to this embodiment, it is preferable that a content of the pigment a configuring the resin dispersion be 4 mass % or more and 12 mass % or less. In the ink according to this embodiment, setting the content of the pigment a configuring the resin dispersion to 4 mass % or more facilitates obtaining the image having the desired image density. In the ink according to this embodiment, setting the content of the pigment a configuring the resin dispersion to 12 mass % or less facilitates ensuring the permeability of the ink to the recording medium. Furthermore, in the ink according to this embodiment, setting the content of the pigment a configuring the resin dispersion to 12 mass % or less facilitates ensuring fluidity of the pigment dispersion, thereby making it easier to obtain the desired image density.

In the ink according to this embodiment, it is preferable that the pigment dispersion resin coat a surface of the pigment a. This allows the ink according to this embodiment to suppress agglomeration of the pigment dispersion, where a film (layer) including the pigment dispersion resin is formed on the surface of the pigment a. Note that the ink according to this embodiment may contain the pigment dispersion resin (non-adsorbed resin) that is not adsorbed onto the surface of the pigment a. Furthermore, the ink according to this embodiment preferably contains an anionic pigment dispersion resin.

The pigment dispersion resin may be appropriately selected and used from known pigment dispersion resins. Specific examples of the pigment dispersion resin include a styrene-acrylic resin, a styrene-maleic acid copolymer, a styrene-maleic acid half-ester copolymer, a vinylnaphthalene-acrylic acid copolymer, or a vinylnaphthalene-maleic acid copolymer. The styrene-acrylic resin is a resin containing a unit derived from styrene and a unit derived from acrylic acid, methacrylic acid, an acrylic acid ester, or a methacrylic acid ester. Examples of the styrene-acrylic resin include a styrene-acrylic acid-alkyl acrylate ester copolymer, a styrene-methacrylic acid-alkyl methacrylate ester-alkyl acrylate ester copolymer, a styrene-acrylic acid copolymer, a styrene-maleic acid-alkyl acrylate ester copolymer, a styrene-methacrylic acid copolymer, or a styrene-alkyl methacrylate-alkyl acrylate ester copolymer. Among these pigment dispersion resins, because it is easy to prepare and exhibits an excellent dispersion effect for the pigment a, the styrene-acrylic resin is preferred, the styrene-methacrylic acid-alkyl methacrylate-alkyl acrylate ester copolymer is more preferred, and a methacrylic acid-methyl methacrylate-butyl acrylate-styrene copolymer is particularly preferred.

In the ink according to this embodiment, it is preferable that the content of the pigment dispersion resin be 15 parts by mass or more and 100 parts by mass or less per 100 parts by mass of the pigment a. In the ink according to this embodiment, setting the content of the pigment dispersion resin to 15 parts by mass or more per 100 parts by mass of the pigment a suppresses an occurrence of bleed-through in the recording medium after image formation. In the ink according to this embodiment, setting the content of the pigment dispersion resin to 100 parts by weight or less per 100 parts by mass of the pigment a makes it less likely that insufficient permeation into the recording medium will occur due to increased viscosity.

Furthermore, in the ink according to this embodiment, the pigment dispersion resin may configure a specific resin having a crosslinked structure formed by a crosslinking agent on the surface of the pigment a. That is, in the ink according to this embodiment, the pigment dispersion may have a configuration including the pigment a and the specific resin. In the ink according to this embodiment, the specific resin that coats the pigment a has the crosslinked structure, thereby binding the specific resin to the surface of the pigment a and preventing the specific resin from detaching from the surface of the pigment a. In the ink according to this embodiment, while maintaining an action of suppressing the agglomeration of the pigment a by the pigment dispersion resin, a strong binding force of the specific resin to the surface of the pigment a is obtained, making it easier to maintain a dispersion state of the pigment dispersion.

In the ink according to this embodiment, it is preferable that a crosslinking rate of the specific resin is 25% or more and 90% or less, and more preferably 40% or more and 70% or less. In the ink according to this embodiment, limiting the crosslinking rate of the specific resin to 90% or less facilitates obtaining high image density due to the agglomeration of the pigment dispersion on the recording medium. Furthermore, in the ink according to this embodiment, setting the crosslinking rate of the specific resin to 25% or more effectively suppresses detachment of the pigment a from the surface.

The crosslinking rate indicates a percentage of the number of the functional groups in the specific resin that form crosslinked structures, relative to the total number of the functional groups (groups capable of reacting with the crosslinking agent) in the pigment dispersion resin, which is set at 100%. The crosslinking agent used in the ink according to this embodiment primarily reacts with an acid group (particularly-COOH). Therefore, the “total number of the functional groups contained in the raw material of the pigment dispersion resin” corresponds to the total number of acid groups contained in the pigment dispersion resin. The crosslinking rate is calculated by applying a molar number P of the crosslinking functional groups (epoxy groups) contained in the crosslinking agent and a molar number Q of the carboxyl groups contained in the pigment dispersion resin to the following equation:

Crosslinking rate [%]=100×molar number P of crosslinking functional groups/molar number Q of carboxyl groups

The molar number P of the crosslinking functional groups in the crosslinking agent is calculated by dividing an amount of the crosslinking agent used [g] by an epoxy equivalent weight [g/eq.] of the crosslinking agent. The molar amount Q of the carboxyl groups contained in the specific resin is calculated by multiplying an amount of the specific resin used by the molar amount of the carboxyl groups per 1 gram of the specific resin. The molar number of the carboxyl groups per 1 gram of the specific resin is calculated by dividing an acid value of the copolymer used as the raw material for the specific resin by a molecular weight (56.1) of KOH.

The crosslinking agent preferably contains a polyfunctional epoxy compound X having two or more epoxy groups and one or more hydroxyl groups in its molecule (hereinafter sometimes referred to as polyfunctional epoxy compound X). A water solubility rate of the crosslinking agent is preferably 80% or more, more preferably 90% or more, and further preferably 98% or more. Setting the water solubility rate of the crosslinking agent to 80% or more optimizes dispersion stability of the pigment dispersion. The water solubility rate of the crosslinking agent is a rate of a mass R of the crosslinking agent dissolved in water to a total mass (10 g) of the crosslinking agent (100×R/10 g) when 10 g of the crosslinking agent is mixed with 90 g of water at 25° C. For example, at 25° C., when 10 g of the crosslinking agent is mixed with 90 g of water and 9 g of the crosslinking agent dissolves in water and 1 g remains undissolved and precipitates (mass R: 9 g), the water solubility rate is 90%.

For the multifunctional epoxy compound X, the number of the epoxy groups in the molecule is preferably 2 or more and 8 or less, and more preferably 2 or more and 5 or less. For the multifunctional epoxy compound X, the number of the hydroxyl groups in the molecule is preferably 1 or more and 5 or less, and more preferably 1 or more and 3 or less.

As the polyfunctional epoxy compound X, a glycerol polyglycidyl ether, a polyglycerol polyglycidyl ether (especially diglycerol polyglycidyl ether or triglycerol polyglycidyl ether), or a sorbitol polyglycidyl ether are preferred, and a glycerol polyglycidyl ether, a diglycerol polyglycidyl ether, or a triglycerol polyglycidyl ether are more preferred.

The crosslinking agent may additionally contain another polyfunctional epoxy compound in addition to the polyfunctional epoxy compound X. As another polyfunctional epoxy compound, a compound represented by the following chemical formula (2) (glycerol triglycidyl ether) is preferred. In the crosslinking agent, a total content of the multifunctional epoxy compound X and the glycerol triglycidyl ether is preferably 80 mass % or more, more preferably 95 mass % or more, and further preferably 100 mass %. Examples of the multifunctional epoxy compound X include a compound represented by the following chemical formulae (1), (3), (4), or (5). As the crosslinking agent, a mixture of the compound represented by the chemical formula (1) and the compound represented by the chemical formula (2), the compound represented by the chemical formula (3), the compound represented by the chemical formula (4), or the compound represented by the chemical formula (5) is preferred.

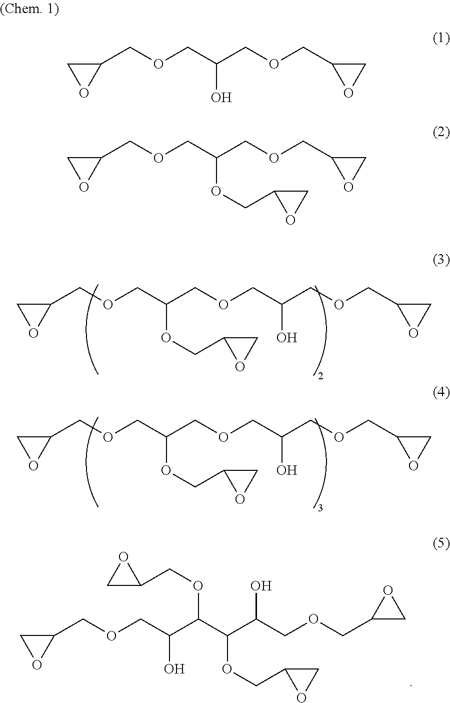

For the crosslinking agent, it is preferable that the epoxy equivalent is 100 g/eq. or more and 250 g/eq. or less, more preferably 130 g/eq. or more and 200 g/eq. or less, and further preferably 130 g/eq. or more and 170 g/eq. or less. The epoxy equivalent is determined according to a method described in JIS (Japanese Industrial Standards) K7236:2009.

### (Wetting Agent b)

In the ink according to this embodiment, to achieve high resistance to curling, an average molecular weight of polyethylene glycol configuring the wetting agent b is 150 or more. Furthermore, in the ink according to this embodiment, to achieve a high intermittent ejection performance, the average molecular weight of polyethylene glycol configuring the wetting agent b is 650 or less. Examples of such polyethylene glycols include PEG200, PEG300, PEG400, PEG600, etc.

In the ink according to this embodiment, the viscosity can be adjusted by a type and an amount of the wetting agent b. In the ink according to this embodiment, it is preferable to adjust the type and the amount of the wetting agent b so that the viscosity at 25° C. is 5.0 mPa·s or less to improve the intermittent ejection performance. In this embodiment, the viscosity of the ink at 25° C. is measured using an E-type viscometer TV-100EL (manufactured by Toki Industries Co., Ltd.).

### (Permeating Agent c)

The permeating agent c in the ink according to this embodiment is configured of at least one selected from the group consisting of triethylene glycol monobutyl ether, 1,2-hexanediol, 1,2-octanediol, 2-methyl-2,4-pentanediol, dipropylene glycol monomethyl ether, and tripropylene glycol monomethyl ether.

Furthermore, the ink according to this embodiment becomes easier to permeate into the recording medium due to an action of the permeating agent c. Moreover, the ink according to this embodiment becomes even easier to permeate into the recording medium due to a decrease in surface tension caused by an action of the surfactant e described below. Therefore, the ink according to this embodiment dries quickly due to its rapid permeation into the recording medium, thereby more effectively suppressing an offset occurrence. In the ink according to this embodiment, dynamic surface tension at a surface lifetime of 10 milliseconds is preferably 40 mN/m or less. In this embodiment, the dynamic surface tension of the ink at the surface lifetime of 10 milliseconds is measured using a bubble pressure dynamic surface tension meter (“BP-100” manufactured by KRUSS).

### (Solid Additive d)

In the ink according to this embodiment, as the solid additive d, which is a water-soluble organic additive, examples include a polyhydric alcohol, amino acids (amino acid or amino acid derivative), and ε-caprolactam, etc., for example.

Examples of the polyhydric alcohol that is solid at 25° C. include a sugar alcohol, trimethylolpropane, trimethylolethane, 1,6-hexanediol, neopentyl glycol, 2-hydroxymethyl-1,3-propanediol, 2-butyl-2-ethyl-1,3-propanediol, 2-ethyl-2-hydroxymethyl-1,3-propanediol, 2-methyl-2-propyl-1,3-propanediol, 2-ethyl-2-methyl-1,3-propanediol, and 2-sec-butyl-2-methyl-1,3-propanediol. Examples of the sugar alcohol that is solid at 25° C. include, for example, sorbitol, maltitol, erythritol, pentaerythritol, xylitol, and mannitol. Examples of the amino acids that are solid at 25° C. include, for example, betaine, proline, lysine, arginine, and carnitine.

### (Surfactant e)

The ink according to this embodiment preferably contains the surfactant e. In the ink according to this embodiment, an action of the surfactant e improves compatibility and dispersion stability of each component. Furthermore, in the ink according to this embodiment, an action of the surfactant e to improve the permeability (wetting) into the recording medium suppresses the offset occurrence while enhancing the image density. A nonionic surfactant is preferred as the surfactant e.

As the nonionic surfactant used as the surfactant e, an acetylene glycol surfactant (surfactant containing acetylene glycol compound) is preferred. Other examples include a silicone surfactant (surfactant containing silicone compound) and a fluorine surfactant (surfactant containing fluororesin or fluorine-containing compound), for example. Examples of the acetylene glycol surfactant include an ethylene oxide adduct of acetylene glycol and a propylene oxide adduct of acetylene glycol. An example of a commercially available product of the acetylene glycol surfactant includes, for example, “Olfin E1010” manufactured by Nissin Chemical Industry Co.

In the ink according to this embodiment, a content of the nonionic surfactant is preferably 0.05 mass % or more and 2.0 mass % or less, more preferably 0.1 mass % or more and 2.0 mass % or less, and further preferably 0.2 mass % or more and 0.6 mass % or less.

### (Water)

The water contained in the water-based ink for inkjet recording of the present disclosure is preferably ion-exchanged water (deionized water). A content of the water is preferably 50 mass % or more and 80 mass % or less relative to the total mass of the ink.

Furthermore, the ink according to this embodiment may optionally include various additives such as a solubility stabilizer, an anti-drying agent, an antioxidant, a viscosity modifier, a pH adjuster, a neutralizing agent, and an antifungal agent, as needed.

### EXAMPLES AND COMPARATIVE EXAMPLES

Each ink is prepared and evaluated as Examples of the present disclosure and Comparative Examples. Note that the following examples are merely illustrative of the present disclosure, and configurations of the present disclosure are not limited to the configurations of the examples.

### (Evaluation Method)

First, an evaluation method for each ink according to Examples and Comparative Examples will be described. Each ink according to Examples and Comparative Examples was evaluated for the intermittent ejection performance, the image density, the redispersibility, and resistance to offset and curling occurrences.

### Intermittent Ejection Performance

The intermittent ejection performance was evaluated by maintaining an interior of the recording head at 25° C. under environments of 10° C. and 15% RH. Specifically, for each ink, the recording head formed a first line image on the recording medium, then passed through a non-image forming area without forming an image, and subsequently formed a second line image identical to the first line image. Microscopic observation was then used to determine whether or not distortion occurred in the second line image. For each ink, the maximum dimension size M (mm) of the non-image forming area in a transport direction where no distortion occurred in the second line image was determined. An evaluation value for the intermittent ejection performance was calculated as a numerical value corresponding to the maximum dimension size M when a dimension size equivalent to an A3 size in a longitudinal direction (420 mm) was set to 100 (=100×(M/420)). Each evaluation value was evaluated using the following criteria A and B. For the intermittent ejection performance, the ink evaluated A or B was considered pass, while the ink evaluated C was considered fail.
A: 110 or more
B: 100 or more and less than 110
C: less than 100

### Image Density

A solid image measuring 10 cm×10 cm was formed on the recording medium (“C2” (A4 size) manufactured by Fujifilm Business Innovation Corporation) with an ink ejection volume of 11 μL one time per nozzle of the recording head. The recording medium with the solid image formed was kept under environments of room temperature and normal humidity for one day and one night. Subsequently, for each solid image, the image density was measured at 10 locations using a portable reflectance densitometer RD-19 (manufactured by Gretag Macbeth Co., Ltd.). An average value of the 10 image densities was taken as an evaluation value for the image density. The evaluation value was evaluated using the following criteria A and B. For the image density, the ink evaluated as A or B was considered pass, while the ink evaluated as C was considered fail.
A: 1.15 or more
B: 1.1 or more and less than 1.15
C: less than 1.1

### Redispersibility

A petri dish containing 2 g of each ink was set to an incubator and was held at 40° C. for 72 hours. After the holding, the ion-exchanged water was added to each ink at a rate of 5 mL/sec. When 10 seconds were elapsed after the addition, it was visually observed whether or not pigment particles in each ink were dispersed in a solvent. Each observation result was evaluated based on the following criteria A and B. For the redispersibility, the ink evaluated A was considered pass, and the ink evaluated B was considered fail.
A: pigment particles were dispersed in water
B: pigment particles were not dispersed in water

### Resistance to Offset Occurrence

First, the ink was filled into a recording head positioned closest to the exit roller on the evaluation machine. Excess liquid flowing onto a nozzle surface was scraped off using a wipe blade. On the evaluation machine, a distance between the nozzle surface of the recording head and the recording medium was fixed at 1 mm. A transport speed of the recording medium from a feed roller to the exit roller was set to 846.7 mm/sec. The recording media used were “IJW” manufactured by Oji Paper Co., Ltd. cut to A4 size. Using the evaluation machine, a solid image of 10 cm×10 cm was formed continuously on 10 sheets of the recording media, with an ink deposition rate from the recording head to the recording media set to 15 g/m². For the tenth recording medium, an area prone to smudging (offset area) due to the ink adhering to the exit roller was scanned using an image scanner (“GT-X820” manufactured by Seiko Epson Corporation) and binarized at a threshold of 220. An offset area rate (%) (=100×number of black pixels/total number of pixels) was calculated from the number of black pixels and the total number of pixels in a binarized image. This offset area rate was used as an evaluation value for the resistance to offset occurrence. For the evaluation value, visual inspection was used to determine the smudging of the recording medium due to the offset. The following criteria A and B were applied for the evaluation. For the resistance to the offset occurrence, the ink evaluated A was considered pass, while the ink evaluated B was considered fail.
A: 0.030% or less
B: more than 0.030%

### Resistance to Curling Occurrence

The solid image of 10 cm×10 cm was formed on the recording medium (“C2” (A4 size) manufactured by Fujifilm Business Innovation Corporation) using the ink ejection volume of 11 μL one time per nozzle of the recording head. Immediately afterward, the recording medium with the solid image formed was arranged on a top surface of a horizontal table so that the solid image on the recording medium faced the top surface of the horizontal table. Heights of four corners of the recording medium above the top surface of the horizontal table were then measured. An average height of the four corners of the recording medium was used as an evaluation value for resistance to curling occurrence. For the evaluation value, a 0.8 kPa suction fan was used, suction and adhesion was performed via the transport belt, and the recording medium was corrected using a decal mechanism. It was evaluated whether or not adhesion of the recording medium for forming an image on a second side (reverse side) of a double-sided print was possible. The following criteria A and B were applied for the evaluation. For the resistance to the curling occurrence, the ink evaluated A was considered pass, while the ink evaluated B was considered fail.
A: 20 mm or less
B: more than 20 mm

### Examples 1-1 to 1-7

In Examples 1-1 to 1-7, erythritol, a sugar alcohol solid at 25° C., was used as the solid additive d. Furthermore, in Examples 1-1 to 1-7, the self-dispersing pigment was used as the pigment a, and no pigment dispersion resin was blended.

In Examples 1-1 to 1-7, the inks were prepared to have a composition shown in Table 1. In all of Examples 1-1 to 1-7, a self-dispersing pigment (BONJET CW-4, carbon concentration 13%, manufactured by Orient Chemical Industry Co., Ltd.) was used as the pigment a, polyethylene glycol 400 (manufactured by Sanyo Chemical Industries, Ltd.) was used as the wetting agent b, and triethylene glycol monobutyl ether (manufactured by Tokyo Chemical Industry Co., Ltd.) was used as the permeating agent c, erythritol (manufactured by Tokyo Chemical Industry Co., Ltd.) was used as the solid additive d, Olfin E1010 (manufactured by Nissin Chemical Industry Co., Ltd.) was used as the surfactant e, and ion-exchanged water was used as the water. Each ink of Examples 1-1 to 1-7 was prepared by placing the above ingredients in a beaker and mixing the contents of the beaker for 30 minutes at a rotation speed of 400 rpm using a stirrer (“Three One Motor BL-600” manufactured by Shinto Kagaku Co., Ltd.). Foreign matters and coarse particles were removed from each ink by filtration using a filter (pore size 5 μm).

TABLE 1

| | Component (mass %) | | | | | |
|---|---|---|---|---|---|---|
| Exam- | Pig- | PEG | | | Surfac- | |
| ple | ment | 400 | BTG | Erythritol | tant | Water |
| 1-1 | 5 | 12 | 3 | 10 | 0.5 | Remain- |
| | | | | | | der |
| 1-2 | 5 | 20 | 10 | 15 | 0.5 | Remain- |
| | | | | | | der |
| 1-3 | 5 | 7 | 1 | 3 | 0.5 | Remain- |
| | | | | | | der |
| 1-4 | 5 | 20 | 10 | 3 | 0.5 | Remain- |
| | | | | | | der |
| 1-5 | 5 | 7 | 1 | 15 | 0.5 | Remain- |
| | | | | | | der |
| 1-6 | 5 | 20 | 1 | 15 | 0.5 | Remain- |
| | | | | | | der |
| 1-7 | 5 | 7 | 10 | 3 | 0.5 | Remain- |
| | | | | | | der |

The inks of Examples 1-1 to 1-7 were evaluated for the intermittent ejection performance, the image density, the redispersibility, and the resistance to offset and curling occurrences. Table 2 shows the evaluation results for the intermittent ejection performance, the image density, the redispersibility, and the resistance to offset and curling occurrences for the inks of Examples 1-1 to 1-7. All inks of Examples 1-1 to 1-7 passed the evaluation for the intermittent ejection performance, the image density, the redispersibility, and the resistance to offset and curling occurrences.

TABLE 2

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Eval- | | | Eval- | | Evaluation | |
| | uation | Eval- | uation | Eval- | Redispersibility | uation | Eval- | value | Eval- |
| Example | value | uation | value | uation | Evaluation | value (%) | uation | (mm) | uation |
| 1-1 | 125 | A | 1.22 | A | A | 0.018 | A | 16 | A |
| 1-2 | 115 | A | 1.21 | A | A | 0.016 | A | 5 | A |
| 1-3 | 110 | A | 1.16 | A | A | 0.027 | A | 20 | A |
| 1-4 | 135 | A | 1.17 | A | A | 0.029 | A | 8 | A |
| 1-5 | 110 | A | 1.15 | A | A | 0.014 | A | 17 | A |
| 1-6 | 115 | A | 1.15 | A | A | 0.029 | A | 5 | A |
| 1-7 | 110 | A | 1.23 | A | A | 0.021 | A | 18 | A |

### Comparative Examples 1-1 to 1-8

In Comparative Examples 1-1 to 1-8, the inks were prepared using the same method as in Examples 1-1 to 1-7 to achieve the compositions shown in Tables 3 to 5. The ink of Comparative Example 1-1 differs from the inks of Examples 1-1 to 1-7 in that it does not contain the permeating agent c. The ink of Comparative Example 1-2 differs from the inks of Examples 1-1 to 1-7 in that the content of the permeating agent c is more than 10 mass %. The ink of Comparative Example 1-3 differs from the inks of Examples 1-1 to 1-7 in that the content of the wetting agent b is less than 7 mass %. The ink of Comparative Example 1-4 differs from the inks of Examples 1-1 to 1-7 in that the content of the wetting agent b is more than 15 mass %. The ink of Comparative Example 1-5 differs from the inks of Examples 1-1 to 1-7 in that it does not contain the solid additive d. The ink of Comparative Example 1-6 differs from the inks of Examples 1-1 to 1-7 in that the content of the solid additive d is more than 15 mass %. The ink of Comparative Example 1-7 differs from the inks of Examples 1-1 to 1-7 in that the average molecular weight of polyethylene glycol is more than 650. The ink of Comparative Examples 1-8 differs from the inks of Examples 1-1 to 1-7 in that diethylene glycol (average molecular weight: 106.12) was used instead of the wetting agent b.

TABLE 3

| Compar- | Component (mass %) | | | | | |
|---|---|---|---|---|---|---|
| ative | Pig- | PEG | | | Surfac- | |
| example | ment | 400 | BTG | Erythritol | tant | Water |
| 1-1 | 5 | 20 | — | 10 | 0.5 | Remain- |
| | | | | | | der |
| 1-2 | 5 | 7 | 15 | 3 | 0.5 | Remain- |
| | | | | | | der |
| 1-3 | 5 | 5 | 3 | 10 | 0.5 | Remain- |
| | | | | | | der |
| 1-4 | 5 | 25 | 3 | 10 | 0.5 | Remain- |
| | | | | | | der |
| 1-5 | 5 | 12 | 3 | — | 0.5 | Remain- |
| | | | | | | der |
| 1-6 | 5 | 12 | 3 | 20 | 0.5 | Remain- |
| | | | | | | der |

TABLE 4

| | | Component (mass %) | | | | | |
|---|---|---|---|---|---|---|---|
| | | Pig- | PEG | | | Surfac- | |
| | | ment | 1000 | BTG | Erythritol | ctant | Water |
| Compar- | 1-7 | 5 | 12 | 3 | 10 | 0.5 | Remain- |
| ative | | | | | | | der |
| example | | | | | | | |

TABLE 5

| | | Component (mass %) | | | | | |
|---|---|---|---|---|---|---|---|
| | | Pig- | | | | Surfac- | |
| | | ment | DEG | BTG | Erythritol | tant | Water |
| Compar- | 1-8 | 5 | 12 | 3 | 10 | 0.5 | Remain- |
| ative | | | | | | | der |
| example | | | | | | | |

The inks of Comparative Examples 1-1 to 1-8 were evaluated for the intermittent ejection performance, the image density, the redispersibility, and the resistance to offset and curling occurrences. Table 6 shows the evaluation results for the intermittent ejection performance, the image density, the redispersibility, and the resistance to offset and curling occurrences for the inks of Comparative Examples 1-1 to 1-8. The ink of Comparative Example 1-1, which did not contain the permeating agent c, failed the evaluation for the resistance to offset occurrence. The ink of Comparative Example 1-2, which contained more than 10 mass % of the permeating agent c, failed the evaluation for the redispersibility. The ink of Comparative Example 1-3, which contained less than 7 mass % of the wetting agent b, failed the evaluation for the resistance to curling occurrence. The ink of Comparative Example 1-4, which contained more than 15 mass % of the wetting agent b, failed the evaluation for the resistance to offset occurrence. The ink of Comparative Example 1-5, which did not contain the solid additive d, failed the evaluation for the resistance to offset occurrence. The ink of Comparative Example 1-6, which contained more than 15 mass % of the solid additive d, failed the evaluation for the intermittent ejection performance. The ink of Comparative Example 1-7, where the average molecular weight of polyethylene glycol was more than 650, failed the evaluation for the intermittent ejection performance. The ink of Comparative Example 1-8, where diethylene glycol was used instead of the wetting agent b, failed the evaluation for the resistance to curling occurrence.

TABLE 6

| | Evaluation results | | | | | | | | |
|---|---|---|---|---|---|---|---|---|---|
| | Intermittent ejection | | | | | | | | |
| | performance | | Image density | | | Offset | | Curl | |
| Compar- | Evalu- | | Evalu- | | | Evaluation | | Evaluation | |
| ative | ation | Evalu- | ation | Evalu- | Redispersibility | value | Evalu- | value | Evalu- |
| example | value | ation | value | ation | Evaluation | (%) | ation | (mm) | ation |
| 1-1 | 120 | A | 1.15 | A | A | 0.032 | B | 5 | A |
| 1-2 | 110 | A | 1.24 | A | B | 0.025 | A | 18 | A |
| 1-3 | 105 | B | 1.20 | A | A | 0.017 | A | 21 | B |
| 1-4 | 140 | A | 1.18 | A | A | 0.033 | B | 5 | A |
| 1-5 | 135 | A | 1.21 | A | A | 0.032 | B | 18 | A |
| 1-6 | 95 | C | 1.21 | A | A | 0.012 | A | 11 | A |
| 1-7 | 90 | C | 1.22 | A | A | 0.017 | A | 14 | A |
| 1-8 | 120 | A | 1.21 | A | A | 0.019 | A | 22 | B |

### Examples 2-1 to 2-11

In Examples 2-1 to 2-11, erythritol, a sugar alcohol solid at 25° C., was used as the solid additive d. Furthermore, in Examples 2-1 to 2-11, the pigment dispersion resin was used, and the pigment dispersion resin was crosslinked on the surface of the pigment a to form the specific resin.

In Examples 2-1 to 2-11, an intermediate pigment dispersion solution was first prepared as a preliminary step before crosslinking the pigment dispersion resin. In all Examples 2-1 to 2-11, Black Pearls 800 (manufactured by Cabot Corporation) was used as the pigment a, and DISPERBYK-190 (manufactured by BYK-Chemie AG) was used as the pigment dispersion resin. A mixture was obtained by mixing the pigment a, the pigment dispersion resin, and ion-exchanged water. The resulting mixture was subjected to a 4-hour dispersion process using a bead mill (“Dyno-mill” manufactured by Willy A. Bachofen AG) to obtain the intermediate pigment dispersion. Zirconia beads (diameter 0.5 mm) were used as the media during the dispersion process. Furthermore, a media filling rate in the bead mill vessel during the dispersion process was set to 60 volume %. Furthermore, a processing temperature (chiller temperature) during the dispersion process was set to 10° C. After the dispersion process, the media were removed. The resulting intermediate pigment dispersion was then filtered through a filter having a pore size of 5 μm to remove impurities and coarse particles.

Next, a 1 L three-neck flask equipped with a thermometer and a stirring paddle was used as a reaction vessel. The intermediate pigment dispersion was added to the reaction vessel. Using a water bath, an internal temperature of the reaction vessel was maintained at 30° C. while the crosslinking agent was added and thoroughly stirred. The content of the reaction vessel was then stirred at 150 rpm for one hour. The crosslinking agent used was “Denacore (registered trademark) EX-313” manufactured by Nagase ChemteX Corporation. The internal temperature of the reaction vessel was then raised to 80° C. at a heating rate of 0.5° C./min while stirring at 250 rpm. While maintaining the internal temperature of the reaction vessel at 80° C., the content was stirred at 250 rpm for 4 hours. The reaction vessel was then cooled to room temperature to obtain the pigment dispersions. Following the above procedure, five pigment dispersions were prepared by changing the crosslinking rates of the pigment dispersion resin to 20%, 25%, 40%, 90%, and 100%.

In Examples 2-1 to 2-11, polyethylene glycol 400 (Sanyo Chemical Industries, Ltd.) was used as the wetting agent b, triethylene glycol monobutyl ether (Tokyo Chemical Industry Co., Ltd.) was used as the permeating agent c, erythritol (Tokyo Chemical Industry Co., Ltd.) was used as the solid additive d, Olfin E1010 (Nissin Chemical Industry Co., Ltd.) was used as the surfactant e, and ion-exchanged water was used as the water. In Examples 2-1 to 2-7, the pigment dispersion liquid with the crosslinking rate of 40% for the specific resin was used. In Example 2-8, the pigment dispersion with the specific crosslinking rate of 25% was used. In Example 2-9, the pigment dispersion with the specific crosslinking rate of 90% was used. In Example 2-10, the pigment dispersion with the specific crosslinking rate of 20% was used. In Example 2-11, the pigment dispersion with the specific crosslinking rate of 100% was used. The inks of Examples 2-1 to 2-11 were prepared by stirring the pigment dispersions and the above components to achieve the compositions shown in Table 7. Table 7 also shows the crosslinking rates of the specific resins for Examples 2-1 to 2-11.

TABLE 7

| | Component (mass %) | | | | | | | | |
|---|---|---|---|---|---|---|---|---|---|
| | | | Cross- | | | | | | Crosslinking |
| | | | linking | PEG | | | | | rate of |
| Example | Pigment | Resin | agent | 400 | BTG | Erythritol | Surfactant | Water | resin |
| 2-1 | 5 | 2 | 0.20 | 12 | 3 | 10 | 0.5 | Remain- | 40% |
| | | | | | | | | der | |
| 2-2 | 5 | 2 | 0.20 | 20 | 10 | 15 | 0.5 | Remain- | 40% |
| | | | | | | | | der | |
| 2-3 | 5 | 2 | 0.20 | 7 | 1 | 3 | 0.5 | Remain- | 40% |
| | | | | | | | | der | |
| 2-4 | 5 | 2 | 0.20 | 20 | 10 | 3 | 0.5 | Remain- | 40% |
| | | | | | | | | der | |
| 2-5 | 5 | 2 | 0.20 | 7 | 1 | 15 | 0.5 | Remain- | 40% |
| | | | | | | | | der | |
| 2-6 | 5 | 2 | 0.20 | 20 | 1 | 15 | 0.5 | Remain- | 40% |
| | | | | | | | | der | |
| 2-7 | 5 | 2 | 0.20 | 7 | 10 | 3 | 0.5 | Remain- | 40% |
| | | | | | | | | der | |
| 2-8 | 5 | 2 | 0.13 | 12 | 3 | 10 | 0.5 | Remain- | 25% |
| | | | | | | | | der | |
| 2-9 | 5 | 2 | 0.45 | 12 | 3 | 10 | 0.5 | Remain- | 90% |
| | | | | | | | | der | |
| 2-10 | 5 | 2 | 0.10 | 12 | 3 | 10 | 0.5 | Remain- | 20% |
| | | | | | | | | der | |
| 2-11 | 5 | 2 | 0.50 | 12 | 3 | 10 | 0.5 | Remain- | 100% |
| | | | | | | | | der | |

The inks of Examples 2-1 to 2-11 were evaluated for the intermittent ejection performance, the image density, the redispersibility, and the resistance to offset and curling occurrences. Table 8 shows the evaluation results for the intermittent ejection performance, the image density, the redispersibility, and the resistance to offset and curling occurrences for the inks of Examples 2-1 to 2-11. All inks of Examples 2-1 to 2-11 passed the evaluations for the intermittent ejection performance, the image density, the redispersibility, and the resistance to offset and curling occurrences. Furthermore, Examples 2-1 to 2-9, where the crosslinking rate of the specific resin was 25% or more and 90% or less, yielded particularly good evaluation results for both of the intermittent ejection performance and the image density.

TABLE 8

| | Evaluation results | | | | | | | | |
|---|---|---|---|---|---|---|---|---|---|
| | Intermittent ejection | | | | | | | | |
| | performance | | Image density | | | Offset | | Curl | |
| | Evalu- | | Evalu- | | | Evaluation | | Evaluation | |
| | ation | Evalu- | ation | Evalu- | Redispersibility | value | Evalu- | value | Evalu- |
| Example | value | ation | value | ation | Evaluation | (%) | ation | (mm) | ation |
| 2-1 | 120 | A | 1.18 | A | A | 0.016 | A | 15 | A |
| 2-2 | 110 | A | 1.20 | A | A | 0.014 | A | 6 | A |
| 2-3 | 110 | A | 1.15 | A | A | 0.026 | A | 20 | A |
| 2-4 | 130 | A | 1.17 | A | A | 0.028 | A | 9 | A |
| 2-5 | 110 | A | 1.15 | A | A | 0.012 | A | 16 | A |
| 2-6 | 115 | A | 1.15 | A | A | 0.028 | A | 6 | A |
| 2-7 | 110 | A | 1.21 | A | A | 0.020 | A | 18 | A |
| 2-8 | 120 | A | 1.19 | A | A | 0.016 | A | 15 | A |
| 2-9 | 120 | A | 1.15 | A | A | 0.016 | A | 15 | A |
| 2-10 | 100 | B | 1.20 | A | A | 0.016 | A | 15 | A |
| 2-11 | 120 | A | 1.11 | B | A | 0.016 | A | 15 | A |

### Comparative Examples 2-1 to 2-8

In Comparative Examples 2-1 to 2-8, the inks were prepared using the same method as in Examples 2-1 to 2-11 to achieve the compositions shown in Tables 9 to 11. In Comparative Examples 2-1 to 2-8, the pigment dispersion with the crosslinking rate of 40% for the specific resin was used in each case. The ink of Comparative Example 2-1 differs from the inks of Examples 2-1 to 2-11 in that it does not contain the permeating agent c. The ink of Comparative Example 2-2 differs from the inks of Examples 2-1 to 2-11 in that the content of the permeating agent c is more than 10 mass %. The ink of Comparative Example 2-3 differs from the inks of Examples 2-1 to 2-11 in that the content of the wetting agent b is less than 7 mass %. The ink of Comparative Example 2-4 differs from the inks of Examples 2-1 to 2-11 in that it contains more than 15 mass % of the wetting agent b. The ink of Comparative Example 2-5 differs from the inks of Examples 2-1 to 2-11 in that it does not contain the solid additive d. The ink of Comparative Example 2-6 differs from the inks of Examples 2-1 to 2-11 in that the content of the solid additive d is more than 15 mass %. The ink of Comparative Example 2-7 differs from the inks of Examples 2-1 to 2-11 in that the average molecular weight of polyethylene glycol is more than 650. The ink of Comparative Example 2-8 differs from the inks of Examples 2-1 to 2-11 in that diethylene glycol (average molecular weight: 106.12) was used instead of the wetting agent b.

TABLE 9

| | Component (mass %) | | | | | | | | |
|---|---|---|---|---|---|---|---|---|---|
| Compar- | | | Cross- | | | | | | Crosslinking |
| ative | | | linking | PEG | | | | | rate of |
| example | Pigment | Resin | agent | 400 | BTG | Erythritol | Surfactant | Water | resin |
| 2-1 | 5 | 2 | 0.20 | 20 | — | 10 | 0.5 | Remain- | 40% |
| | | | | | | | | der | |
| 2-2 | 5 | 2 | 0.20 | 7 | 15 | 3 | 0.5 | Remain- | 40% |
| | | | | | | | | der | |
| 2-3 | 5 | 2 | 0.20 | 5 | 3 | 10 | 0.5 | Remain- | 40% |
| | | | | | | | | der | |
| 2-4 | 5 | 2 | 0.20 | 25 | 3 | 10 | 0.5 | Remain- | 40% |
| | | | | | | | | der | |
| 2-5 | 5 | 2 | 0.20 | 12 | 3 | — | 0.5 | Remain- | 40% |
| | | | | | | | | der | |
| 2-6 | 5 | 2 | 0.20 | 12 | 3 | 20 | 0.5 | Remain- | 40% |
| | | | | | | | | der | |

TABLE 10

| | Component (mass %) | | | | | | | | |
|---|---|---|---|---|---|---|---|---|---|
| Compar- | | | Cross- | | | | | | Crosslinking |
| ative | | | linking | PEG | | | | | rate of |
| example | Pigment | Resin | agent | 1000 | BTG | Erythritol | Surfactant | Water | resin |
| 2-7 | 5 | 2 | 0.20 | 12 | 3 | 10 | 0.5 | Remain- | 40% |
| | | | | | | | | der | |

TABLE 11

| | Component (mass %) | | | | | | | | |
|---|---|---|---|---|---|---|---|---|---|
| Compar- | | | Cross- | | | | | | Crosslinking |
| ative | | | linking | | | | | | rate of |
| example | Pigment | Resin | agent | DEG | BTG | Erythritol | Surfactant | Water | resin |
| 2-8 | 5 | 2 | 0.20 | 12 | 3 | 10 | 0.5 | Remain- | 40% |
| | | | | | | | | der | |

The inks of Comparative Examples 2-1 to 2-8 were evaluated for the intermittent ejection performance, the image density, the redispersibility, and the resistance to offset and curling occurrences. Table 12 shows the evaluation results for the intermittent ejection performance, the image density, the redispersibility, and the resistance to offset and curling occurrences for the inks of Comparative Examples 2-1 to 2-8. The ink of Comparative Example 2-1, which did not contain the permeating agent c, failed the evaluation for the resistance to offset occurrence. The ink of Comparative Example 2-2, which contained more than 10 mass % of permeating agent c, failed the evaluation for the redispersibility. The ink of Comparative Example 2-3, which contained less than 7 mass % of the wetting agent b, failed the evaluation for the resistance to curling occurrence. The ink of Comparative Example 2-4, which contained more than 15 mass % of the wetting agent b, failed the evaluation for the resistance to offset occurrence. The ink of Comparative Example 2-5, which did not contain the solid additive d, failed the evaluation for the resistance to offset occurrence. The ink of Comparative Example 2-6, which contained more than 15 mass % of the solid additive d, failed the evaluation for the intermittent ejection performance. The ink of Comparative Example 2-7, where the average molecular weight of polyethylene glycol was more than 650, failed the evaluation for the intermittent ejection performance. The ink of Comparative Example 2-8, where diethylene glycol was used instead of the wetting agent b, failed the evaluation for the resistance to curling occurrence.

TABLE 12

| | Evaluation results | | | | | | | | |
|---|---|---|---|---|---|---|---|---|---|
| | Intermittent ejection | | | | | | | | |
| | performance | | Image density | | | Offset | | Curl | |
| Compar- | Evalu- | | Evalu- | | | Evaluation | | Evaluation | |
| ative | ation | Evalu- | ation | Evalu- | Redispersibility | value | Evalu- | value | Evalu- |
| example | value | ation | value | ation | Evaluation | (%) | ation | (mm) | ation |
| 2-1 | 115 | A | 1.15 | A | A | 0.031 | B | 6 | A |
| 2-2 | 110 | A | 1.22 | A | B | 0.023 | A | 17 | A |
| 2-3 | 110 | A | 1.19 | A | A | 0.015 | A | 22 | B |
| 2-4 | 135 | A | 1.16 | A | A | 0.033 | B | 4 | A |
| 2-5 | 130 | A | 1.18 | A | A | 0.031 | B | 19 | A |
| 2-6 | 95 | C | 1.18 | A | A | 0.011 | A | 12 | A |
| 2-7 | 90 | C | 1.19 | A | A | 0.015 | A | 14 | A |
| 2-8 | 120 | A | 1.17 | A | A | 0.017 | A | 23 | B |

### Examples 3-1 to 3-7

In Examples 3-1 to 3-7, trimethylolpropane (TMP), a polyhydric alcohol solid at 25° C., was used as the solid additive d. Furthermore, in Examples 3-1 to 3-7, the self-dispersing pigment was used as the pigment a, and no pigment dispersion resin was blended.

In Examples 3-1 to 3-7, the inks were prepared to have the compositions shown in Table 13. In Examples 3-1 to 3-7, the self-dispersing pigment (BONJET CW-4, carbon concentration 13%, manufactured by Orient Chemical Industry Co., Ltd.) was used as the pigment a, polyethylene glycol 400 (Sanyo Chemical Industries, Ltd.) was used as the wetting agent b, and triethylene glycol monobutyl ether (Tokyo Chemical Industry Co., Ltd.) was used as the permeating agent c, trimethylolpropane (Tokyo Chemical Industry Co., Ltd.) was used as the solid additive d, Olfin E1010 (Nissin Chemical Industry Co., Ltd.) was used as the surfactant e, and ion-exchanged water was used as the water. The inks of Examples 3-1 to 3-7 were prepared by placing the above components in the beaker and mixing the contents of the beaker for 30 minutes at the rotation speed of 400 rpm using the stirrer (“Three One Motor BL-600” manufactured by Shinto Kagaku Co., Ltd.). Foreign matters and coarse particles were removed from each ink by filtration using the filter (pore size 5 μm).

TABLE 13

| | Component (mass %) | | | | | |
|---|---|---|---|---|---|---|
| Exam- | Pig- | PEG | | | Surfa- | |
| ple | ment | 400 | BTG | TMP | ctant | Water |
| 3-1 | 5 | 12 | 3 | 10 | 0.5 | Remain- |
| | | | | | | der |
| 3-2 | 5 | 20 | 10 | 15 | 0.5 | Remain- |
| | | | | | | der |
| 3-3 | 5 | 7 | 1 | 3 | 0.5 | Remain- |
| | | | | | | der |
| 3-4 | 5 | 20 | 10 | 3 | 0.5 | Remain- |
| | | | | | | der |
| 3-5 | 5 | 7 | 1 | 15 | 0.5 | Remain- |
| | | | | | | der |
| 3-6 | 5 | 20 | 1 | 15 | 0.5 | Remain- |
| | | | | | | der |
| 3-7 | 5 | 7 | 10 | 3 | 0.5 | Remain- |
| | | | | | | der |

The inks of Examples 3-1 to 3-7 were evaluated for the intermittent ejection performance, the image density, the redispersibility, and the resistance to offset and curling occurrences. Table 14 shows the evaluation results for the intermittent ejection performance, the image density, the redispersibility, and the resistance to offset and curling occurrences for the inks of Examples 3-1 to 3-7. All inks of Examples 3-1 to 3-7 passed the evaluations for the intermittent ejection performance, the image density, the redispersibility, and the resistance to offset and curling occurrences.

TABLE 14

| | Evaluation results | | | | | | | | |
|---|---|---|---|---|---|---|---|---|---|
| | Intermittent ejection | | | | | | | | |
| | performance | | Image density | | | Offset | | Curl | |
| | Evalu- | | Evalu- | | | Evaluation | | Evaluation | |
| | ation | Evalu- | ation | Evalu- | Redispersibility | value | Evalu- | value | Evalu- |
| Example | value | ation | value | ation | Evaluation | (%) | ation | (mm) | ation |
| 3-1 | 125 | A | 1.24 | A | A | 0.019 | A | 17 | A |
| 3-2 | 115 | A | 1.23 | A | A | 0.017 | A | 6 | A |
| 3-3 | 115 | A | 1.18 | A | A | 0.029 | A | 20 | A |
| 3-4 | 135 | A | 1.19 | A | A | 0.030 | A | 9 | A |
| 3-5 | 115 | A | 1.17 | A | A | 0.015 | A | 18 | A |
| 3-6 | 120 | A | 1.17 | A | A | 0.030 | A | 6 | A |
| 3-7 | 110 | A | 1.24 | A | A | 0.022 | A | 19 | A |

### Comparative Examples 3-1 to 3-8

In Comparative Examples 3-1 to 3-8, the inks were prepared using the same method as in Examples 3-1 to 3-7 to achieve the compositions shown in Tables 15 to 17. The ink of Comparative Example 3-1 differs from the inks of Examples 3-1 to 3-7 in that it does not contain the permeating agent c. The ink of Comparative Example 3-2 differs from the inks of Examples 3-1 to 3-7 in that the content of the permeating agent c is more than 10 mass %. The ink of Comparative Example 3-3 differs from the inks of Examples 3-1 to 3-7 in that the content of the wetting agent b is less than 7 mass %. The ink of Comparative Example 3-4 differs from the inks of Examples 3-1 to 3-7 in that the content of the wetting agent b is more than 15 mass %. The ink of Comparative Example 3-5 differs from the inks of Examples 3-1 to 3-7 in that it does not contain the solid additive d. The ink of Comparative Example 3-6 differs from the inks of Examples 3-1 to 3-7 in that the content of the solid additive d is more than 15 mass %. The ink of Comparative Example 3-7 differs from the inks of Examples 3-1 to 3-7 in that the average molecular weight of polyethylene glycol is more than 650. The ink of Comparative Example 3-8 differs from the inks of Examples 3-1 to 3-7 in that diethylene glycol (average molecular weight: 106.12) was used instead of the wetting agent b.

TABLE 15

| Compar- | Component (mass %) | | | | | |
|---|---|---|---|---|---|---|
| ative | Pig- | PEG | | | Surfac- | |
| example | ment | 400 | BTG | TMP | tant | Water |
| 3-1 | 5 | 20 | — | 10 | 0.5 | Remain- |
| | | | | | | der |
| 3-2 | 5 | 7 | 15 | 3 | 0.5 | Remain- |
| | | | | | | der |
| 3-3 | 5 | 5 | 3 | 10 | 0.5 | Remain- |
| | | | | | | der |
| 3-4 | 5 | 25 | 3 | 10 | 0.5 | Remain- |
| | | | | | | der |
| 3-5 | 5 | 12 | 3 | — | 0.5 | Remain- |
| | | | | | | der |
| 3-6 | 5 | 12 | 3 | 20 | 0.5 | Remain- |
| | | | | | | der |

TABLE 16

| Compar- | Component (mass %) | | | | | |
|---|---|---|---|---|---|---|
| ative | Pig- | PEG | | | Surfac- | |
| example | ment | 1000 | BTG | TMP | tant | Water |
| 3-7 | 5 | 12 | 3 | 10 | 0.5 | Remain- |
| | | | | | | der |

TABLE 17

| Compar- | Component (mass %) | | | | | |
|---|---|---|---|---|---|---|
| ative | Pig- | | | | Surfac- | |
| example | ment | DEG | BTG | TMP | tant | Water |
| 3-8 | 5 | 12 | 3 | 10 | 0.5 | Remain- |
| | | | | | | der |

The inks of Comparative Examples 3-1 to 3-8 were evaluated for the intermittent ejection performance, the image density, the redispersibility, and the resistance to offset and curling occurrences. Table 18 shows the evaluation results for the intermittent ejection performance, the image density, the redispersibility, and the resistance to offset and curling occurrences for the inks of Comparative Examples 3-1 to 3-8. The ink of Comparative Example 3-1, which did not contain the permeating agent c, failed the evaluation for the resistance to offset occurrence. The ink of Comparative Example 3-2, which contained more than 10 mass % of the permeating agent c, failed the evaluation for the redispersibility. The ink of Comparative Example 3-3, which contained less than 7 mass % of the wetting agent b, failed the evaluation for the resistance to curling occurrence. The ink of Comparative Example 3-4, which contained more than 15 mass % of the wetting agent b, failed the evaluation for the resistance to offset occurrence. The ink of Comparative Example 3-5, which did not contain the solid additive d, failed the evaluation for the resistance to offset occurrence. The ink of Comparative Example 3-6, which contained more than 15 mass % of the solid additive d, failed the evaluation for the intermittent ejection performance. The ink of Comparative Example 3-7, where the average molecular weight of polyethylene glycol was more than 650, failed the evaluation for the intermittent ejection performance. The ink of Comparative Example 3-8, where diethylene glycol was used instead of the wetting agent b, failed the evaluation for the resistance to curling occurrence.

TABLE 18

| | Evaluation results | | | | | | | | |
|---|---|---|---|---|---|---|---|---|---|
| | Intermittent ejection | | | | | | | | |
| | performance | | Image density | | | Offset | | Curl | |
| Compar- | Evalu- | | Evalu- | | | Evaluation | | Evaluation | |
| ative | ation | Evalu- | ation | Evalu- | Redispersibility | value | Evalu- | value | Evalu- |
| example | value | ation | value | ation | Evaluation | (%) | ation | (mm) | ation |
| 3-1 | 120 | A | 1.13 | B | A | 0.032 | B | 5 | A |
| 3-2 | 100 | B | 1.24 | A | B | 0.025 | A | 18 | A |
| 3-3 | 105 | B | 1.20 | A | A | 0.017 | A | 21 | B |
| 3-4 | 140 | A | 1.18 | A | A | 0.033 | B | 5 | A |
| 3-5 | 135 | A | 1.21 | A | A | 0.032 | B | 18 | A |
| 3-6 | 95 | C | 1.21 | A | A | 0.012 | A | 11 | A |
| 3-7 | 90 | C | 1.22 | 4 | A | 0.017 | A | 14 | A |
| 3-8 | 120 | A | 1.21 | A | A | 0.019 | A | 22 | B |

### Examples 4-1 to 4-11

In Examples 4-1 to 4-11, trimethylolpropane (TMP), a polyhydric alcohol solid at 25° C., was used as the solid additive d. Furthermore, in Examples 4-1 to 4-11, the pigment dispersion resin was used, and the pigment dispersion resin was crosslinked on the surface of the pigment a to form the specific resin.

In Examples 4-1 to 4-11, an intermediate pigment dispersion solution was first prepared as a preliminary step before crosslinking the pigment dispersion resin. In all Examples 4-1 to 4-11, Black Pearls 800 (manufactured by Cabot Corporation) was used as the pigment a, and DISPERBYK-190 (manufactured by BYK-Chemie AG) was used as the pigment dispersion resin. The mixture was obtained by mixing the pigment a, the pigment dispersion resin, and deionized water. The resulting mixture was subjected to the 4-hour dispersion process using the bead mill (“Dyno-mill” manufactured by Willy A. Bachofen AG) to obtain the intermediate pigment dispersion. Zirconia beads (diameter 0.5 mm) were used as the media during the dispersion process. Furthermore, the media filling rate in the bead mill vessel during the dispersion temperature) during the dispersion process was set to 10° C. After the dispersion process, the media were removed. The resulting intermediate pigment dispersion was then filtered through the filter having the pore size of 5 μm to remove impurities and coarse particles.

Next, the 1 L three-neck flask equipped with the thermometer and the stirring paddle was used as the reaction vessel. The intermediate pigment dispersion was added to the reaction vessel. Using the water bath, the internal temperature of the reaction vessel was maintained at 30° C. while the crosslinking agent was added and thoroughly stirred. The content of the reaction vessel was then stirred at 150 rpm for one hour. The crosslinking agent used was “Denacore (registered trademark) EX-313” manufactured by Nagase ChemteX Corporation. The internal temperature of the reaction vessel was then raised to 80° C. at the heating rate of 0.5° C./min while stirring at 250 rpm. While maintaining the internal temperature of the reaction vessel at 80° C., the content was stirred at 250 rpm for 4 hours. The reaction vessel was then cooled until the internal temperature reached room temperature to obtain the pigment dispersions. Following the above procedure, five pigment dispersions were prepared by changing the crosslinking rates of the pigment dispersion resin to 20%, 25%, 40%, 90%, and 100%.

In Examples 4-1 to 4-11, polyethylene glycol 400 (Sanyo Chemical Industries, Ltd.) was used as the wetting agent b, triethylene glycol monobutyl ether (Tokyo Chemical Industry Co., Ltd.) was used as the permeating agent c, trimethylolpropane (Tokyo Chemical Industry Co., Ltd.) was used as the solid additive d, Olfin E1010 (Nissin Chemical Industry Co., Ltd.) was used as the surfactant e, and ion-exchanged water was used as the water. In Examples 4-1 to 4-7, the pigment dispersion liquid with the crosslinking rate of 40% for the specific resin was used. In Example 4-8, the pigment dispersion with the specific crosslinking rate of 25% was used. In Example 4-9, the pigment dispersion with the specific crosslinking rate of 90% was used. In Example 4-10, the pigment dispersion with the specific crosslinking rate of 20% was used. In Example 4-11, the pigment dispersion with the specific crosslinking rate of 100% was used. The inks of Examples 4-1 to 4-11 were prepared by stirring the pigment dispersions and the above components to achieve the compositions shown in Table 19. Table 19 also shows the crosslinking rates of the specific resins for Examples 4-1 to 4-11.

TABLE 19

| Component (mass %) | | | Crosslinking |
|---|---|---|---|
| | Crosslinking | PEG | rate of |

| Example | Pigment | Resin | agent | 400 | BTG | TMP | Surfactant | Water | resin |
|---|---|---|---|---|---|---|---|---|---|
| 4-1 | 5 | 2 | 0.20 | 12 | 3 | 1C | 0.5 | Remain- | 40% |
| | | | | | | | | der | |
| 4-2 | 5 | 2 | 0.20 | 20 | 10 | 15 | 0.5 | Remain- | 40% |
| | | | | | | | | der | |
| 4-3 | 5 | 2 | 0.20 | 7 | 1 | 3 | 0.5 | Remain- | 40% |
| | | | | | | | | der | |
| 4-4 | 5 | 2 | 0.20 | 20 | 10 | 3 | 0.5 | Remain- | 40% |
| | | | | | | | | der | |
| 4-5 | 5 | 2 | 0.20 | 7 | 1 | 15 | 0.5 | Remain- | 40% |
| | | | | | | | | der | |
| 4-6 | 5 | 2 | 0.20 | 20 | 1 | 15 | 0.5 | Remain- | 40% |
| | | | | | | | | der | |
| 4-7 | 5 | 2 | 0.20 | 7 | 10 | 3 | 0.5 | Remain- | 40% |
| | | | | | | | | der | |
| 4-8 | 5 | 2 | 0.13 | 12 | 3 | 10 | 0.5 | Remain- | 25% |
| | | | | | | | | der | |
| 4-9 | 5 | 2 | 0.45 | 12 | 3 | 10 | 0.5 | Remain- | 90% |
| | | | | | | | | der | |
| 4-10 | 5 | 2 | 0.10 | 12 | 3 | 10 | 0.5 | Remain- | 20% |
| | | | | | | | | der | |
| 4-11 | 5 | 2 | 0.50 | 12 | 3 | 10 | 0.5 | Remain- | 100% |
| | | | | | | | | der | |

The inks of Examples 4-1 to 4-11 were evaluated for the intermittent ejection performance, the image density, redispersibility, and resistance to offset and the curling occurrences. Table 20 shows the evaluation results for the intermittent ejection performance, the image density, the redispersibility, and the resistance to offset and curling occurrences for the inks of Examples 4-1 to 4-11. All inks of Examples 4-1 to 4-11 passed the evaluations for the intermittent ejection performance, the image density, the redispersibility, and the resistance to offset and curling occurrences. Furthermore, Examples 4-1 to 4-9, where the crosslinking rate of the specific resin was 25% or more and 90% or less, yielded particularly good evaluation results for both of the intermittent ejection performance and image density.

TABLE 20

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Evalu- | | | Eval- | | Eval- | |
| | uation | Eval- | ation | Eval- | Redispersibility | uation | Eval- | uation | Eval- |
| Example | value | uation | value | uation | Evaluation | value (%) | uation | value (mm) | uation |
| 4-1 | 120 | A | 1.20 | A | A | 0.017 | A | 16 | A |
| 4-2 | 115 | A | 1.22 | A | A | 0.015 | A | 6 | A |
| 4-3 | 110 | A | 1.16 | A | A | 0.028 | A | 20 | A |
| 4-4 | 130 | A | 1.18 | A | A | 0.029 | A | 10 | A |
| 4-5 | 115 | A | 1.17 | A | A | 0.011 | A | 17 | A |
| 4-6 | 120 | A | 1.15 | A | A | 0.029 | A | 7 | A |
| 4-7 | 110 | A | 1.22 | A | A | 0.021 | A | 19 | A |
| 4-8 | 120 | A | 1.21 | A | A | 0.016 | A | 15 | A |
| 4-9 | 120 | A | 1.15 | A | A | 0.017 | A | 15 | A |
| 4-10 | 100 | B | 1.20 | A | A | 0.016 | A | 15 | A |
| 4-11 | 120 | A | 1.11 | B | A | 0.016 | A | 15 | A |

### Comparative Examples 4-1 to 4-8

In Comparative Examples 4-1 to 4-8, the inks were prepared using the same method as in Examples 4-1 to 4-11 to achieve the compositions shown in Tables 21 to 23. In Comparative Examples 4-1 to 4-8, the pigment dispersion with the crosslinking rate of 40% for the specific resin was used in each case. The ink of Comparative Example 4-1 differs from the inks of Examples 4-1 to 4-11 in that it does not contain the permeating agent c. The ink of Comparative Example 4-2 differs from the inks of Examples 4-1 to 4-11 in that the content of the permeating agent c is more than 10 mass %. The ink of Comparative Example 4-3 differs from the inks of Examples 4-1 to 4-11 in that the content of the wetting agent b is less than 7 mass %. The ink of Comparative Example 4-4 differs from the inks of Examples 4-1 to 4-11 in that it contains more than 15 mass % of the wetting agent b. The ink of Comparative Example 4-5 differs from the inks of Examples 4-1 to 4-11 in that it does not contain the solid additive d. The ink of Comparative Example 4-6 differs from the inks of Examples 4-1 to 4-11 in that the content of the solid additive d is more than 15 mass %. The ink of Comparative Example 4-7 differs from the inks of Examples 4-1 to 4-11 in that the average molecular weight of polyethylene glycol is more than 650. The ink of Comparative Example 4-8 differs from the inks of Examples 4-1 to 4-11 in that diethylene glycol (average molecular weight: 106.12) was used instead of the wetting agent b.

TABLE 21

| | |
|---|---|
| Component (mass %) | Crosslinking |

| Comparative | | | Crosslinking | PEG | | | | | rate of |
|---|---|---|---|---|---|---|---|---|---|
| example | Pigment | Resin | agent | 400 | BTG | TMP | Surfactant | Water | resin |
| 4-1 | 5 | 2 | 0.20 | 20 | — | 10 | 0.5 | Remain- | 40% |
| | | | | | | | | der | |
| 4-2 | 5 | 2 | 0.20 | 7 | 15 | 3 | 0.5 | Remain- | 40% |
| | | | | | | | | der | |
| 4-3 | 5 | 2 | 0.20 | 5 | 3 | 10 | 0.5 | Remain- | 40% |
| | | | | | | | | der | |
| 4-4 | 5 | 2 | 0.20 | 25 | 3 | 10 | 0.5 | Remain- | 40% |
| | | | | | | | | der | |
| 4-5 | 5 | 2 | 0.20 | 12 | 3 | — | 0.5 | Remain- | 40% |
| | | | | | | | | der | |
| 4-6 | 5 | 2 | 0.20 | 12 | 3 | 20 | 0.5 | Remain- | 40% |
| | | | | | | | | der | |

TABLE 22

| | |
|---|---|
| Component (mass %) | Crosslinking |

| Comparative | | | Crosslinking | PEG | | | | | rate of |
|---|---|---|---|---|---|---|---|---|---|
| example | Pigment | Resin | agent | 1000 | BTG | TMP | Surfactant | Water | resin |
| 4-7 | 5 | 2 | 0.20 | 12 | 3 | 10 | 0.5 | Remain- | 40% |
| | | | | | | | | der | |

TABLE 23

| | Component (mass %) | | | | | | | | Crosslinking |
|---|---|---|---|---|---|---|---|---|---|
| Comparative | | | Crosslinking | | | | | | rate of |
| example | Pigment | Resin | agent | DEG | BTG | TMP | Surfactant | Water | resin |
| 4-8 | 5 | 2 | 0.20 | 12 | 3 | 10 | 0.5 | Remain- | 40% |
| | | | | | | | | der | |

The inks of Comparative Examples 4-1 to 4-8 were evaluated for the intermittent ejection performance, the image density, the redispersibility, and the resistance to offset and curling occurrences. Table 24 shows the evaluation results for the intermittent ejection performance, the image density, the redispersibility, and the resistance to offset and curling occurrences for the inks of Comparative Examples 4-1 to 4-8. The ink of Comparative Example 4-1, which did not contain the permeating agent c, failed the evaluation for the resistance to offset occurrence. The ink of Comparative Example 4-2, which contained more than 10 mass % of the permeating agent c, failed the evaluation for the redispersibility. The ink of Comparative Example 4-3, which contained less than 7 mass % of the wetting agent b, failed the evaluation for the resistance to curling occurrence. The ink of Comparative Example 4-4, which contained more than 15 mass % of the wetting agent b, failed the evaluation for the resistance to offset occurrence. The ink of Comparative Example 4-5, which did not contain the solid additive d, failed the evaluation for the resistance to offset occurrence. The ink of Comparative Example 4-6, which contained more than 15 mass % of the solid additive d, failed the evaluation for the intermittent ejection performance. The ink of Comparative Example 4-7, where the average molecular weight of polyethylene glycol was more than 650, failed the evaluation for the intermittent ejection performance. The ink of Comparative Example 4-8, where diethylene glycol was used instead of the wetting agent b, failed the evaluation for the resistance to curling occurrence.

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Evalu- | | | Eval- | | Eval- | |
| Comparative | uation | Eval- | ation | Eval- | Redispersibility | uation | Eval- | uation | Eval- |
| Example | value | uation | value | uation | Evaluation | value (%) | uation | value (mm) | uation |
| 4-1 | 115 | A | 1.12 | B | A | 0.031 | B | 6 | A |
| 4-2 | 100 | B | 1.22 | A | B | 0.023 | A | 17 | A |
| 4-3 | 105 | B | 1.19 | A | A | 0.015 | A | 22 | B |
| 4-4 | 135 | A | 1.16 | A | A | 0.033 | B | 4 | A |
| 4-5 | 130 | A | 1.18 | A | A | 0.031 | B | 19 | A |
| 4-6 | 95 | C | 1.18 | A | A | 0.011 | A | 12 | A |
| 4-7 | 90 | C | 1.19 | A | A | 0.015 | A | 14 | A |
| 4-8 | 120 | A | 1.17 | A | A | 0.017 | A | 23 | B |

### Examples 5-1 to 5-7

In Examples 5-1 to 5-7, betaine, one of the amino acids that are solid at 25° C., was used as the solid additive d. Furthermore, in Examples 5-1 to 5-7, the self-dispersing pigment was used as the pigment a, and no pigment dispersion resin was blended.

In Examples 5-1 to 5-7, the inks were prepared to have the composition shown in Table 25. In Examples 5-1 to 5-7, the self-dispersing pigment (BONJET CW-4, carbon concentration 13%, manufactured by Orient Chemical Industry Co., Ltd.) was used as the pigment a, polyethylene glycol 400 (Sanyo Chemical Industries, Ltd.) was used as the wetting agent b, and triethylene glycol monobutyl ether (Tokyo Chemical Industry Co., Ltd.) was used as the permeating agent c, betaine (Tokyo Chemical Industry Co., Ltd.) was used as the solid additive d, Olfin E1010 (Nissin Chemical Industry Co., Ltd.) was used as the surfactant e, and ion-exchanged water was used as the water. The inks of Examples 5-1 to 5-7 were prepared by placing the above ingredients in the beaker and mixing the contents of the beaker for 30 minutes at the rotation speed of 400 rpm using the stirrer (“Three One Motor BL-600” manufactured by Shinto Kagaku Co., Ltd.). Foreign matters and coarse particles were removed from each ink by filtration using the filter (pore size 5 μm).

TABLE 25

| | Component (mass %) | | | | | |
|---|---|---|---|---|---|---|
| | Pig- | PEG | | | Surfac- | |
| Example | ment | 400 | BTG | Betaine | tant | Water |
| 5-1 | 5 | 12 | 3 | 10 | 0.5 | Remain- |
| | | | | | | der |
| 5-2 | 5 | 20 | 10 | 15 | 0.5 | Remain- |
| | | | | | | der |
| 5-3 | 5 | 7 | 1 | 3 | 0.5 | Remain- |
| | | | | | | der |
| 5-4 | 5 | 20 | 10 | 3 | 0.5 | Remain- |
| | | | | | | der |
| 5-5 | 5 | 7 | 1 | 15 | 0.5 | Remain- |
| | | | | | | der |
| 5-6 | 5 | 20 | 1 | 15 | 0.5 | Remain- |
| | | | | | | der |
| 5-7 | 5 | 7 | 10 | 3 | 0.5 | Remain- |
| | | | | | | der |

The inks of Examples 5-1 to 5-7 were evaluated for the intermittent ejection performance, the image density, the redispersibility, and the resistance to offset and curling occurrences. Table 26 shows the evaluation results for the intermittent ejection performance, the image density, the redispersibility, and the resistance to offset and curling occurrences for the inks of Examples 5-1 to 5-7. All inks of Examples 5-1 to 5-7 passed the evaluations for the intermittent ejection performance, the image density, the redispersibility, and the resistance to offset and curling occurrences.

TABLE 26

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Evalu- | | | Eval- | | Eval- | |
| | uation | Eval- | ation | Eval- | Redispersibility | uation | Eval- | uation | Eval- |
| Example | value | uation | value | uation | Evaluation | value (%) | uation | value (mm) | uation |
| 5-1 | 123 | A | 1.18 | A | A | 0.016 | A | 14 | A |
| 5-2 | 117 | A | 1.18 | A | A | 0.015 | A | 4 | A |
| 5-3 | 111 | A | 1.16 | A | A | 0.025 | A | 18 | A |
| 5-4 | 132 | A | 1.15 | A | A | 0.028 | A | 7 | A |
| 5-5 | 110 | A | 1.16 | A | A | 0.015 | A | 16 | A |
| 5-6 | 117 | A | 1.15 | A | A | 0.029 | A | 4 | A |
| 5-7 | 110 | A | 1.20 | A | A | 0.020 | A | 16 | A |

### Comparative Examples 5-1 to 5-8

In Comparative Examples 5-1 to 5-8, the inks were prepared using the same method as in Examples 5-1 to 5-7 to achieve the compositions shown in Tables 27 to 29. The ink of Comparative Example 5-1 differs from the inks of Examples 5-1 to 5-7 in that it does not contain the permeating agent c. The ink of Comparative Example 5-2 differs from the inks of Examples 5-1 to 5-7 in that the content of the permeating agent c is more than 10 mass %. The ink of Comparative Example 5-3 differs from the inks of Examples 5-1 to 5-7 in that the content of the wetting agent b is less than 7 mass %. The ink of Comparative Example 5-4 differs from the inks of Examples 5-1 to 5-7 in that the content of the wetting agent b is more than 15 mass %. The ink of Comparative Example 5-5 differs from the inks of Examples 5-1 to 5-7 in that it does not contain the solid additive d. The ink of Comparative Example 5-6 differs from the inks of Examples 5-1 to 5-7 in that the content of the solid additive d is more than 15 mass %. The ink of Comparative Example 5-7 differs from the inks of Examples 5-1 to 5-7 in that the average molecular weight of polyethylene glycol is more than 650. The ink of Comparative Example 5-8 differs from the inks of Examples 5-1 to 5-7 in that diethylene glycol (average molecular weight: 106.12) was used instead of the wetting agent b.

TABLE 27

| | Component (mass %) | | | | | |
|---|---|---|---|---|---|---|
| Comparative | Pig- | PEG | | | Surfac- | |
| Example | ment | 400 | BTG | Betaine | tant | Water |
| 5-1 | 5 | 20 | — | 10 | 0.5 | Remain- |
| | | | | | | der |
| 5-2 | 5 | 7 | 15 | 3 | 0.5 | Remain- |
| | | | | | | der |
| 5-3 | 5 | 5 | 3 | 10 | 0.5 | Remain- |
| | | | | | | der |
| 5-4 | 5 | 25 | 3 | 10 | 0.5 | Remain- |
| | | | | | | der |
| 5-5 | 5 | 12 | 3 | — | 0.5 | Remain- |
| | | | | | | der |
| 5-6 | 5 | 12 | 3 | 20 | 0.5 | Remain- |
| | | | | | | der |

TABLE 28

| | Component (mass %) | | | | | |
|---|---|---|---|---|---|---|
| Comparative | Pig- | PEG | | | Surfac- | |
| Example | ment | 1000 | BTG | Betaine | tant | Water |
| 5-7 | 5 | 12 | 3 | 10 | 0.5 | Remain- |
| | | | | | | der |

TABLE 29

| | Component (mass %) | | | | | |
|---|---|---|---|---|---|---|
| Comparative | Pig- | | | | Surfac- | |
| Example | ment | DEG | BTG | Betaine | tant | Water |
| 5-8 | 5 | 12 | 3 | 10 | 0.5 | Remain- |
| | | | | | | der |

The inks of Comparative Examples 5-1 to 5-8 were evaluated for the intermittent ejection performance, the image density, the redispersibility, and the resistance to offset and curling occurrences. Table 30 shows the evaluation results for the intermittent ejection performance, the image density, the redispersibility, and the resistance to offset and curling occurrences for the inks of Comparative Examples 5-1 to 5-8. The ink of Comparative Example 5-1, which did not contain the permeating agent c, failed the evaluation for the resistance to offset occurrence. The ink of Comparative Example 5-2, which contained more than 10 mass % of the permeating agent c, failed the evaluation for the redispersibility. The ink of Comparative Example 5-3, which contained less than 7 mass % of the wetting agent b, failed the evaluation for the resistance to curling occurrence. The ink of Comparative Example 5-4, which contained more than 15 mass % of the wetting agent b, failed the evaluation for the resistance to offset occurrence. The ink of Comparative Example 5-5, which did not contain the solid additive d, failed the evaluation for the resistance to offset occurrence. The ink of Comparative Example 5-6, which contained more than 15 mass % of the solid additive d, failed the evaluation for the intermittent ejection performance. The ink of Comparative Example 5-7, where the average molecular weight of polyethylene glycol was more than 650, failed the evaluation for the intermittent ejection performance. The ink of Comparative Example 5-8, where diethylene glycol was used instead of the wetting agent b, failed the evaluation for the resistance to curling occurrence.

TABLE 30

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Evalu- | | | Eval- | | Eval- | |
| Comparative | uation | Eval- | ation | Eval- | Redispersibility | uation | Eval- | uation | Eval- |
| Example | value | uation | value | uation | Evaluation | value (%) | uation | value (mm) | uation |
| 5-1 | 122 | A | 1.15 | A | A | 0.033 | B | 4 | A |
| 5-2 | 110 | A | 1.20 | A | B | 0.024 | A | 19 | A |
| 5-3 | 110 | A | 1.15 | A | A | 0.015 | A | 21 | B |
| 5-4 | 135 | A | 1.16 | A | A | 0.033 | B | 4 | A |
| 5-5 | 135 | A | 1.21 | A | A | 0.032 | B | 18 | A |
| 5-6 | 94 | C | 1.17 | A | A | 0.011 | A | 10 | A |
| 5-7 | 91 | C | 1.19 | A | A | 0.016 | A | 12 | A |
| 5-8 | 119 | A | 1.18 | A | A | 0.018 | A | 21 | B |

### Examples 6-1 to 6-11

In Examples 6-1 to 6-11, betaine, one of the amino acids that are solid at 25° C., was used as the solid additive d. Furthermore, in Examples 6-1 to 6-11, the pigment dispersion resin was used, and the pigment dispersion resin was crosslinked on the surface of the pigment a to form the specific resin.

In Examples 6-1 to 6-11, the intermediate pigment dispersion solution was first prepared as the preliminary step before crosslinking the pigment dispersion resin. In all Examples 6-1 to 6-11, Black Pearls 800 (manufactured by Cabot Corporation) was used as the pigment a, and DISPERBYK-190 (manufactured by BYK-Chemie AG) was used as the pigment dispersion resin. The mixture was obtained by mixing the pigment a, the pigment dispersion resin, and ion-exchanged water. The resulting mixture was subjected to the 4-hour dispersion process using the bead mill (“Dyno-mill” manufactured by Willy A. Bachofen AG) to obtain the intermediate pigment dispersion. Zirconia beads (diameter 0.5 mm) were used as the media during the dispersion process. Furthermore, the media filling rate in the bead mill vessel during the dispersion temperature) during the dispersion process was set to 10° C. After the dispersion process, the media were removed. The resulting intermediate pigment dispersion was then filtered through the filter having the pore size of 5 μm to remove impurities and coarse particles.

Next, the 1 L three-neck flask equipped with the thermometer and the stirring paddle was used as the reaction vessel. The intermediate pigment dispersion was added to the reaction vessel. Using the water bath, the internal temperature of the reaction vessel was maintained at 30° C. while the crosslinking agent was added and thoroughly stirred. The content of the reaction vessel was then stirred at 150 rpm for one hour. The crosslinking agent used was “Denacore (registered trademark) EX-313” manufactured by Nagase ChemteX Corporation. Subsequently, while stirring at 250 rpm, the internal temperature of the reaction vessel was raised to 80° C. at the heating rate of 0.5° C./min. While maintaining the internal temperature of the reaction vessel at 80° C., the content was stirred at 250 rpm for 4 hours. The reaction vessel was then cooled to room temperature to obtain the pigment dispersions. Following the above procedure, five pigment dispersions were prepared with crosslinking rates of 20%, 25%, 40%, 90%, and 100%.

In Examples 6-1 to 6-11, polyethylene glycol 400 (Sanyo Chemical Industries, Ltd.) was used as the wetting agent b, triethylene glycol monobutyl ether (Tokyo Chemical Industry Co., Ltd.) was used as the permeating agent c, betaine (Tokyo Chemical Industry Co., Ltd.) was used as the solid additive d, Olfin E1010 (Nissin Chemical Industry Co., Ltd.) was used as the surfactant e, and ion-exchanged water was used as the water. In Examples 6-1 to 6-7, the pigment dispersion with the specific resin crosslinking rate of 40% was used. In Example 6-8, the pigment dispersion with the specific crosslinking rate of 25% was used. In Example 6-9, the pigment dispersion with the specific crosslinking rate of 90% was used. In Example 6-10, the pigment dispersion with the specific crosslinking rate of 20% was used. In Example 6-11, the pigment dispersion with the specific crosslinking rate of 100% was used. The inks of Examples 6-1 to 6-11 were prepared by stirring the pigment dispersions and the above components to achieve the compositions shown in Table 31. Table 31 also shows the crosslinking rates of the specific resins for Examples 6-1 to 6-11.

TABLE 31

| | Component (mass %) | | | | | | | | Crosslinking |
|---|---|---|---|---|---|---|---|---|---|
| | | | Crosslinking | PEG | | | | | rate of |
| Example | Pigment | Resin | agent | 400 | BTG | Betaine | Surfactant | Water | resin |
| 6-1 | 5 | 2 | 0.20 | 12 | 3 | 10 | 0.5 | Remain- | 40% |
| | | | | | | | | der | |
| 6-2 | 5 | 2 | 0.20 | 20 | 10 | 15 | 0.5 | Remain- | 40% |
| | | | | | | | | der | |
| 6-3 | 5 | 2 | 0.20 | 7 | 1 | 3 | 0.5 | Remain- | 40% |
| | | | | | | | | der | |
| 6-4 | 5 | 2 | 0.20 | 20 | 10 | 3 | 0.5 | Remain- | 40% |
| | | | | | | | | der | |
| 6-5 | 5 | 2 | 0.20 | 7 | 1 | 15 | 0.5 | Remain- | 40% |
| | | | | | | | | der | |
| 6-6 | 5 | 2 | 0.20 | 20 | 1 | 15 | 0.5 | Remain- | 40% |
| | | | | | | | | der | |
| 6-7 | 5 | 2 | 0.20 | 7 | 10 | 3 | 0.5 | Remain- | 40% |
| | | | | | | | | der | |
| 6-8 | 5 | 2 | 0.13 | 12 | 3 | 10 | 0.5 | Remain- | 25% |
| | | | | | | | | der | |
| 6-9 | 5 | 2 | 0.45 | 12 | 3 | 10 | 0.5 | Remain- | 90% |
| | | | | | | | | der | |
| 6-10 | 5 | 2 | 0.10 | 12 | 3 | 10 | 0.5 | Remain- | 20% |
| | | | | | | | | der | |
| 6-11 | 5 | 2 | 0.50 | 12 | 3 | 10 | 0.5 | Remain- | 100% |
| | | | | | | | | der | |

The inks of Examples 6-1 to 6-11 were evaluated for the intermittent ejection performance, the image density, the redispersibility, and the resistance to offset and curling occurrences. Table 32 shows the evaluation results for the intermittent ejection performance, the image density, the redispersibility, and the resistance to offset and curling occurrences for the inks of Examples 6-1 to 6-11. All inks of Examples 6-1 to 6-11 passed the evaluations for the intermittent ejection performance, the image density, the redispersibility, and the resistance to offset and curling occurrences. Furthermore, Examples 6-1 to 6-9, where the crosslinking rate of the specific resin was 25% or more and 90% or less, yielded particularly good evaluation results for both of the intermittent ejection performance and image density.

TABLE 32

| | Evaluation results | | | | | | | | |
|---|---|---|---|---|---|---|---|---|---|
| | Intermittent ejection | | | | | | | | |
| | performance | | Image density | | | Offset | | Curl | |
| | Eval- | | Evalu- | | | Eval- | | Eval- | |
| | uation | Eval- | ation | Eval- | Redispersibility | uation | Eval- | uation | Eval- |
| Example | value | uation | value | uation | Evaluation | value (%) | uation | value (mm) | uation |
| 6-1 | 122 | A | 1.16 | A | A | 0.015 | A | 12 | A |
| 6-2 | 111 | A | 1.17 | A | A | 0.014 | A | 5 | A |
| 6-3 | 110 | A | 1.16 | A | A | 0.025 | A | 18 | A |
| 6-4 | 127 | A | 1.16 | A | A | 0.029 | A | 7 | A |
| 6-5 | 110 | A | 1.16 | A | A | 0.011 | A | 15 | A |
| 6-6 | 117 | A | 1.15 | A | A | 0.026 | A | 7 | A |
| 6-7 | 110 | A | 1.18 | A | A | 0.021 | A | 16 | A |
| 6-8 | 121 | A | 1.17 | A | A | 0.014 | A | 14 | A |
| 6-9 | 118 | A | 1.15 | A | A | 0.015 | A | 15 | A |
| 6-10 | 108 | 3 | 1.15 | A | A | 0.015 | A | 14 | A |
| 6-11 | 122 | A | 1.14 | B | A | 0.014 | A | 15 | A |

### Comparative Examples 6-1 to 6-8

In Comparative Examples 6-1 to 6-8, the inks were prepared using the same method as in Examples 6-1 to 6-11 to achieve the compositions shown in Tables 33 to 35. In Comparative Examples 6-1 to 6-8, the pigment dispersion with the crosslinking rate of 40% for the specific resin was used in each case. The ink of Comparative Example 6-1 differs from the inks of Examples 6-1 to 6-11 in that it does not contain the permeating agent c. The ink of Comparative Example 6-2 differs from the inks of Examples 6-1 to 6-11 in that it contains more than 10 mass % of the permeating agent c. The ink of Comparative Example 6-3 differs from the inks of Examples 6-1 to 6-11 in that it contains less than 7 mass % of the wetting agent b. The ink of Comparative Example 6-4 differs from the inks of Examples 6-1 to 6-11 in that it contains more than 15 mass % of the wetting agent b. The ink of Comparative Example 6-5 differs from the inks of Examples 6-1 to 6-11 in that it does not contain the solid additive d. The ink of Comparative Example 6-6 differs from the inks of Examples 6-1 to 6-11 in that the content of the solid additive d is more than 15 mass %. The ink of Comparative Example 6-7 differs from the inks of Examples 6-1 to 6-11 in that the average molecular weight of polyethylene glycol is more than 650. The ink of Comparative Example 6-8 differs from the inks of Examples 6-1 to 6-11 in that diethylene glycol (average molecular weight: 106.12) was used instead of the wetting agent b.

TABLE 33

| | Component (mass %) | | | | | | | | Crosslinking |
|---|---|---|---|---|---|---|---|---|---|
| Comparative | | | Crosslinking | PEG | | | | | rate of |
| Example | Pigment | Resin | agent | 400 | BTG | Betaine | Surfactant | Water | resin |
| 6-1 | 5 | 2 | 0.20 | 20 | — | 10 | 0.5 | Remain- | 40% |
| | | | | | | | | der | |
| 6-2 | 5 | 2 | 0.20 | 7 | 15 | 3 | 0.5 | Remain- | 40% |
| | | | | | | | | der | |
| 6-3 | 5 | 2 | 0.20 | 5 | 3 | 10 | 0.5 | Remain- | 40% |
| | | | | | | | | der | |
| 6-4 | 5 | 2 | 0.20 | 25 | 3 | 10 | 0.5 | Remain- | 40% |
| | | | | | | | | der | |
| 6-5 | 5 | 2 | 0.20 | 12 | 3 | — | 0.5 | Remain- | 40% |
| | | | | | | | | der | |
| 6-6 | 5 | 2 | 0.20 | 12 | 3 | 20 | 0.5 | Remain- | 40% |
| | | | | | | | | der | |

TABLE 34

| | | Component (mass %) | | | | | | | | Cross- |
|---|---|---|---|---|---|---|---|---|---|---|
| | | | | Cross- | | | | | | linking |
| | | | | linking | PEG | | | | | rate of |
| | | Pigment | Resin | agent | 1000 | BTG | Betaine | Surfactant | Water | resin |
| Comparative | 6-7 | 5 | 2 | 0.20 | 12 | 3 | 10 | 0.5 | Remainder | 40% |
| example | | | | | | | | | | |

TABLE 35

| | | Component (mass %) | | | | | | | | Cross- |
|---|---|---|---|---|---|---|---|---|---|---|
| | | | | Cross- | | | | | | linking |
| | | | | linking | | | | | | rate of |
| | | Pigment | Resin | agent | DEG | BTG | Betaine | Surfactant | Water | resin |
| Comparative | 6-8 | 5 | 2 | 0.20 | 12 | 3 | 10 | 0.5 | Remainder | 40% |
| example | | | | | | | | | | |

The inks of Comparative Examples 6-1 to 6-8 were evaluated for the intermittent ejection performance, the image density, the redispersibility, and the resistance to offset and curling occurrences. Table 36 shows the evaluation results for the intermittent ejection performance, the image density, the redispersibility, and the resistance to offset and curling occurrences for the inks of Comparative Examples 6-1 to 6-8. The ink of Comparative Example 6-1, which did not contain the permeating agent c, failed the evaluation for the resistance to offset occurrence. The ink of Comparative Example 6-2, which contained more than 10 mass % of the permeating agent c, failed the evaluation for the redispersibility. The ink of Comparative Example 6-3, which contained less than 7 mass % of the wetting agent b, failed the evaluation for the resistance to curling occurrence. The ink of Comparative Example 6-4, which contained more than 15 mass % of the wetting agent b, failed the evaluation for the resistance to offset occurrence. The ink of Comparative Example 6-5, which did not contain the solid additive d, failed the evaluation for the resistance to offset occurrence. The ink of Comparative Example 6-6, which contained more than 15 mass % of the solid additive d, failed the evaluation for the intermittent ejection performance. The ink of Comparative Example 6-7, where the average molecular weight of polyethylene glycol was more than 650, failed the evaluation for the intermittent ejection performance. The ink of Comparative Example 6-8, where diethylene glycol was used instead of the wetting agent b, failed the evaluation for the resistance to curling occurrence.

TABLE 36

| | | Evaluation results | | | | | | | | |
|---|---|---|---|---|---|---|---|---|---|---|
| | | Intermittent | | | | | | | | |
| | | ejection | | | | | Offset | | Curl | |
| | | performance | | Image density | | | Evalu- | | Evalu- | |
| | | Evalu- | | Evalu- | | Redisper- | ation | | ation | |
| | | ation | Evalu- | ation | Evalu- | sibility | value | Evalu- | value | Evalu- |
| | | value | ation | value | ation | Evaluation | (%) | ation | (mm) | ation |
| Comparative | 6-1 | 113 | A | 1.15 | A | A | 0.032 | B | 5 | A |
| example | 6-2 | 110 | A | 1.20 | A | B | 0.022 | A | 16 | A |
| | 6-3 | 110 | A | 1.17 | A | A | 0.014 | A | 21 | B |
| | 6-4 | 132 | A | 1.16 | A | A | 0.032 | B | 4 | A |
| | 6-5 | 130 | A | 1.18 | A | A | 0.031 | B | 19 | A |
| | 6-6 | 94 | C | 1.16 | A | A | 0.011 | A | 13 | A |
| | 6-7 | 91 | C | 1.18 | A | A | 0.016 | A | 13 | A |
| | 6-8 | 120 | A | 1.15 | A | A | 0.016 | A | 23 | B |

### Examples 7-1 to 7-7

In Examples 7-1 to 7-7, ε-caprolactam was used as the solid additive d. Furthermore, in Examples 7-1 to 7-7, the self-dispersing pigment was used as the pigment a, and no pigment dispersion resin was blended.

In Examples 7-1 to 7-7, the inks were prepared to have the compositions shown in Table 37. In Examples 7-1 to 7-7, the self-dispersing pigment (BONJET CW-4, carbon concentration 13%, manufactured by Orient Chemical Industry Co., Ltd.) was used as the pigment a, polyethylene glycol 400 (Sanyo Chemical Industries, Ltd.) was used as the wetting agent b, and triethylene glycol monobutyl ether (Tokyo Chemical Industry Co., Ltd.) was used as the permeating agent c, ε-caprolactam (Tokyo Chemical Industry Co., Ltd.) was used as the solid additive d, Olfin E1010 (Nissin Chemical Industry Co., Ltd.) was used as the surfactant e, and ion-exchanged water was used as the water. The inks of Examples 7-1 to 7-7 were prepared by placing the above components in the beaker and mixing the contents of the beaker for 30 minutes at the rotation speed of 400 rpm using the stirrer (“Three One Motor BL-600” manufactured by Shinto Kagaku Co., Ltd.). Foreign matters and coarse particles were removed from each ink by filtration using the filter (pore size 5 μm).

TABLE 37

| | | Component (mass %) | | | | | |
|---|---|---|---|---|---|---|---|
| | | Pig- | PEG | | ε-capro- | Sur- | |
| | | ment | 400 | BTG | lactam | factant | Water |
| Ex- | 7-1 | 5 | 12 | 3 | 10 | 0.5 | Remainder |
| ample | 7-2 | 5 | 20 | 10 | 15 | 0.5 | Remainder |
| | 7-3 | 5 | 7 | 1 | 3 | 0.5 | Remainder |
| | 7-4 | 5 | 20 | 10 | 3 | 0.5 | Remainder |
| | 7-5 | 5 | 7 | 1 | 15 | 0.5 | Remainder |
| | 7-6 | 5 | 20 | 1 | 15 | 0.5 | Remainder |
| | 7-7 | 5 | 7 | 10 | 3 | 0.5 | Remainder |

The inks of Examples 7-1 to 7-7 were evaluated for the intermittent ejection performance, the image density, the redispersibility, and the resistance to offset and curling occurrences. Table 38 shows the evaluation results for the intermittent ejection performance, the image density, the redispersibility, and the resistance to offset and curling occurrences for the inks of Examples 7-1 to 7-7. All inks of Examples 7-1 to 7-7 passed the evaluations for the intermittent ejection performance, the image density, the redispersibility, and the resistance to offset and curling occurrences.

TABLE 38

| | | Evaluation results | | | | | | | | |
|---|---|---|---|---|---|---|---|---|---|---|
| | | Intermittent | | | | | | | | |
| | | ejection | | | | | Offset | | Curl | |
| | | performance | | Image density | | | Evalu- | | Evalu- | |
| | | Evalu- | | Evalu- | | Redisper- | ation | | ation | |
| | | ation | Evalu- | ation | Evalu- | sibility | value | Evalu- | value | Evalu- |
| | | value | ation | value | ation | Evaluation | (%) | ation | (mm) | ation |
| Example | 7-1 | 125 | A | 1.22 | A | A | 0.018 | A | 16 | A |
| | 7-2 | 115 | A | 1.21 | A | A | 0.016 | A | 5 | A |
| | 7-3 | 105 | B | 1.16 | A | A | 0.027 | A | 20 | A |
| | 7-4 | 135 | A | 1.17 | A | A | 0.029 | A | 8 | A |
| | 7-5 | 105 | B | 1.15 | A | A | 0.014 | A | 17 | A |
| | 7-6 | 115 | A | 1.15 | A | A | 0.029 | A | 5 | A |
| | 7-7 | 100 | B | 1.23 | A | A | 0.021 | A | 18 | A |

### Comparative Examples 7-1 to 7-8

In Comparative Examples 7-1 to 7-8, the inks were prepared using the same method as in Examples 7-1 to 7-7 to achieve the compositions shown in Tables 39 to 41. The ink of Comparative Example 7-1 differs from the inks of Examples 7-1 to 7-7 in that it does not contain the permeating agent c. The ink of Comparative Example 7-2 differs from the inks of Examples 7-1 to 7-7 in that the content of the permeating agent c is more than 10 mass %. The ink of Comparative Example 7-3 differs from the inks of Examples 7-1 to 7-7 in that the content of the wetting agent b is less than 7 mass %. The ink of Comparative Example 7-4 differs from the inks of Examples 7-1 to 7-7 in that the content of the wetting agent b is more than 15 mass %. The ink of Comparative Example 7-5 differs from the inks of Examples 7-1 to 7-7 in that it does not contain the solid additive d. The ink of Comparative Example 7-6 differs from the inks of Examples 7-1 to 7-7 in that the content of the solid additive d is more than 15 mass %. The ink of Comparative Example 7-7 differs from the inks of Examples 7-1 to 7-7 in that the average molecular weight of polyethylene glycol is more than 650. The ink of Comparative Example 7-8 differs from the inks of Examples 7-1 to 7-7 in that diethylene glycol (average molecular weight: 106.12) was used instead of the wetting agent b.

TABLE 39

| | | Component (mass %) | | | | | |
|---|---|---|---|---|---|---|---|
| | | Pig- | PEG | | ε-capro- | Sur- | |
| | | ment | 400 | BTG | lactam | factant | Water |
| Com- | 7-1 | 5 | 20 | — | 10 | 0.5 | Remainder |
| par- | 7-2 | 5 | 7 | 15 | 3 | 0.5 | Remainder |
| ative | 7-3 | 5 | 5 | 3 | 10 | 0.5 | Remainder |
| ex- | 7-4 | 5 | 25 | 3 | 10 | 0.5 | Remainder |
| ample | 7-5 | 5 | 12 | 3 | — | 0.5 | Remainder |
| | 7-6 | 5 | 12 | 3 | 20 | 0.5 | Remainder |

TABLE 40

| | | Component (mass %) | | | | | |
|---|---|---|---|---|---|---|---|
| | | Pig- | PEG | | ε-capro- | Sur- | |
| | | ment | 400 | BTG | lactam | factant | Water |
| Com- | 7-7 | 5 | 12 | 3 | 10 | 0.5 | Remainder |
| par- | | | | | | | |
| ative | | | | | | | |
| ex- | | | | | | | |
| ample | | | | | | | |

TABLE 41

| | | Component (mass %) | | | | | |
|---|---|---|---|---|---|---|---|
| | | Pig- | | | ε-capro- | Sur- | |
| | | ment | DEG | BTG | lactam | factant | Water |
| Com- | 7-8 | 5 | 12 | 3 | 10 | 0.5 | Remainder |
| par- | | | | | | | |
| ative | | | | | | | |
| ex- | | | | | | | |
| ample | | | | | | | |

The inks of Comparative Examples 7-1 to 7-8 were evaluated for the intermittent ejection performance, the image density, the redispersibility, and the resistance to offset and curling occurrences. Table 42 shows the evaluation results for the intermittent ejection performance, the image density, the redispersibility, and the resistance to offset and curling occurrences for the inks of Comparative Examples 7-1 to 7-8. The ink of Comparative Example 7-1, which did not contain the permeating agent c, failed the evaluation for the resistance to offset occurrence. The ink of Comparative Example 7-2, which contained more than 10 mass % of the permeating agent c, failed the evaluation for the redispersibility. The ink of Comparative Example 7-3, which contained less than 7 mass % of the wetting agent b, failed the evaluation for the resistance to curling occurrence. The ink of Comparative Example 7-4, which contained more than 15 mass % of the wetting agent b, failed the evaluation for the resistance to offset occurrence. The ink of Comparative Example 7-5, which did not contain the solid additive d, failed the evaluation for the resistance to offset occurrence. The ink of Comparative Example 7-6, which contained more than 15 mass % of the solid additive d, failed the evaluation for the intermittent ejection performance. The ink of Comparative Example 7-7, where the average molecular weight of polyethylene glycol was more than 650, failed the evaluation for the intermittent ejection performance. The ink of Comparative Example 7-8, where diethylene glycol was used instead of the wetting agent b, failed the evaluation for the resistance to curling occurrence.

TABLE 42

| | | Evaluation results | | | | | | | | |
|---|---|---|---|---|---|---|---|---|---|---|
| | | Intermittent | | | | | | | | |
| | | ejection | | | | | Offset | | Curl | |
| | | performance | | Image density | | | Evalu- | | Evalu- | |
| | | Evalu- | | Evalu- | | Redisper- | ation | | ation | |
| | | ation | Evalu- | ation | Evalu- | sibility | value | Evalu- | value | Evalu- |
| | | value | ation | value | ation | Evaluation | (%) | ation | (mm) | ation |
| Comparative | 7-1 | 120 | A | 1.13 | B | A | 0.032 | B | 5 | A |
| example | 7-2 | 100 | B | 1.24 | A | B | 0.025 | A | 18 | A |
| | 7-3 | 105 | B | 1.20 | A | A | 0.017 | A | 21 | B |
| | 7-4 | 140 | A | 1.18 | A | A | 0.033 | B | 5 | A |
| | 7-5 | 135 | A | 1.21 | A | A | 0.032 | B | 18 | A |
| | 7-6 | 95 | C | 1.21 | A | A | 0.012 | A | 11 | A |
| | 7-7 | 90 | C | 1.22 | A | A | 0.017 | A | 14 | A |
| | 7-8 | 120 | A | 1.21 | A | A | 0.019 | A | 22 | B |

### Examples 8-1 to 8-11

In Examples 8-1 to 8-11, ε-caprolactam was used as the solid additive d. Furthermore, in Examples 8-1 to 8-11, the pigment dispersion resin was used, and the pigment dispersion resin was crosslinked on the surface of the pigment a to form the specific resin.

In Examples 8-1 to 8-11, the intermediate pigment dispersion solution was first prepared as the preliminary step before crosslinking the pigment dispersion resin. In all Examples 8-1 to 8-11, Black Pearls 800 (manufactured by Cabot Corporation) was used as the pigment a, and DISPERBYK-190 (manufactured by BYK-Chemie AG) was used as the pigment dispersion resin. The mixture was obtained by mixing the pigment a, the pigment dispersion resin, and ion-exchanged water. The resulting mixture was subjected to the 4-hour dispersion process using the bead mill (“Dyno-mill” manufactured by Willy A. Bachofen AG) to obtain the intermediate pigment dispersion. Zirconia beads (diameter 0.5 mm) were used as the media during the dispersion process. Furthermore, the media filling rate in the bead mill vessel during the dispersion temperature) during dispersion process was set to 10° C. After the dispersion process, the media were removed. The resulting intermediate pigment dispersion was then filtered through the filter having the pore size of 5 μm to remove impurities and coarse particles.

Next, the 1 L three-neck flask equipped with the thermometer and the stirring paddle was used as the reaction vessel. The intermediate pigment dispersion was added to the reaction vessel. Using the water bath, the internal temperature of the reaction vessel was maintained at 30° C. The crosslinking agent was then added to the reaction vessel and stirred thoroughly. The content of the reaction vessel was then stirred at 150 rpm for one hour. The crosslinking agent used was “Denacore (registered trademark) EX-313” manufactured by Nagase ChemteX Corporation. Subsequently, while stirring at 250 rpm, the internal temperature of the reaction vessel was raised to 80° C. at the heating rate of 0.5° C./min. While maintaining the internal temperature of the reaction vessel at 80° C., the content was stirred at 250 rpm for 4 hours. The reaction vessel was then cooled to room temperature to obtain the pigment dispersions. Following the above procedure, five pigment dispersions were prepared with crosslinking rates of 20%, 25%, 40%, 90%, and 100%.

In Examples 8-1 to 8-11, polyethylene glycol 400 (Sanyo Chemical Industries, Ltd.) was used as the wetting agent b, triethylene glycol monobutyl ether (Tokyo Chemical Industry Co., Ltd.) was used as the permeating agent c, ε-caprolactam (Tokyo Chemical Industry Co., Ltd.) was used as the solid additive d, Olfin E1010 (Nissin Chemical Industry Co., Ltd.) was used as the surfactant e, and ion-exchanged water was used as the water. In Examples 8-1 to 8-7, the pigment dispersion liquid with the crosslinking rate of 40% for the specific resin was used. In Example 8-8, the pigment dispersion with the specific crosslinking rate of 25% was used. In Example 8-9, the pigment dispersion with the specific crosslinking rate of 90% was used. In Example 8-10, the pigment dispersion with the specific crosslinking rate of 20% was used. In Example 8-11, the pigment dispersion with the specific crosslinking rate of 100% was used. The inks of Examples 8-1 to 8-11 were prepared by stirring the pigment dispersions and the above components to achieve the compositions shown in Table 43. Table 43 also shows the crosslinking rates of the specific resins for Examples 8-1 to 8-11.

TABLE 43

| | | Component (mass %) | | | | | | | | Cross- |
|---|---|---|---|---|---|---|---|---|---|---|
| | | | | Cross- | | | | | | linking |
| | | Pig- | | linking | PEG | | ε-capro- | Sur- | | rate of |
| | | ment | Resin | agent | 400 | BTG | lactam | factant | Water | resin |
| Example | 8-1 | 5 | 2 | 0.20 | 12 | 3 | 10 | 0.5 | Re- | 40% |
| | | | | | | | | | mainder | |
| | 8-2 | 5 | 2 | 0.20 | 20 | 10 | 15 | 0.5 | Re- | 40% |
| | | | | | | | | | mainder | |
| | 8-3 | 5 | 2 | 0.20 | 7 | 1 | 3 | 0.5 | Re- | 40% |
| | | | | | | | | | mainder | |
| | 8-4 | 5 | 2 | 0.20 | 20 | 10 | 3 | 0.5 | Re- | 40% |
| | | | | | | | | | mainder | |
| | 8-5 | 5 | 2 | 0.20 | 7 | 1 | 15 | 0.5 | Re- | 40% |
| | | | | | | | | | mainder | |
| | 8-6 | 5 | 2 | 0.20 | 20 | 1 | 15 | 0.5 | Re- | 40% |
| | | | | | | | | | mainder | |
| | 8-7 | 5 | 2 | 0.20 | 7 | 10 | 3 | 0.5 | Re- | 40% |
| | | | | | | | | | mainder | |
| | 8-8 | 5 | 2 | 0.13 | 12 | 3 | 10 | 0.5 | Re- | 25% |
| | | | | | | | | | mainder | |
| | 8-9 | 5 | 2 | 0.45 | 12 | 3 | 10 | 0.5 | Re- | 90% |
| | | | | | | | | | mainder | |
| | 8-10 | 5 | 2 | 0.10 | 12 | 3 | 10 | 0.5 | Re- | 20% |
| | | | | | | | | | mainder | |
| | 8-11 | 5 | 2 | 0.50 | 12 | 3 | 10 | 0.5 | Re- | 100% |
| | | | | | | | | | mainder | |

The inks of Examples 8-1 to 8-11 were evaluated for the intermittent ejection performance, the image density, the redispersibility, and the resistance to offset and curling occurrences. Table 44 shows the evaluation results for the intermittent ejection performance, the image density, the redispersibility, and the resistance to offset and curling occurrences for the inks of Examples 8-1 to 8-11. All inks of Examples 8-1 to 8-11 passed the evaluations for the intermittent ejection performance, the image density, the redispersibility, and the resistance to offset and curling occurrences. Furthermore, Examples 8-1 to 8-9, where the crosslinking rate of the specific resin was 25% or more and 90% or less, yielded particularly good evaluation results for both of the intermittent ejection performance and image density.

TABLE 44

| | | Evaluation results | | | | | | | | |
|---|---|---|---|---|---|---|---|---|---|---|
| | | Intermittent | | | | | | | | |
| | | ejection | | | | | Offset | | Curl | |
| | | performance | | Image density | | | Evalu- | | Evalu- | |
| | | Evalu- | | Evalu- | | Redisper- | ation | | ation | |
| | | ation | Evalu- | ation | Evalu- | sibility | value | Evalu- | value | Evalu- |
| | | value | ation | value | ation | Evaluation | (%) | ation | (mm) | ation |
| Example | 8-1 | 120 | A | 1.18 | A | A | 0.016 | A | 15 | A |
| | 8-2 | 110 | A | 1.20 | A | A | 0.014 | A | 6 | A |
| | 8-3 | 110 | A | 1.15 | A | A | 0.026 | A | 20 | A |
| | 8-4 | 130 | A | 1.17 | A | A | 0.028 | A | 9 | A |
| | 8-5 | 110 | A | 1.15 | A | A | 0.012 | A | 16 | A |
| | 8-6 | 115 | A | 1.15 | A | A | 0.028 | A | 6 | A |
| | 8-7 | 110 | A | 1.21 | A | A | 0.020 | A | 18 | A |
| | 8-8 | 120 | A | 1.19 | A | A | 0.016 | A | 15 | A |
| | 8-9 | 120 | A | 1.15 | A | A | 0.016 | A | 15 | A |
| | 8-10 | 100 | B | 1.20 | A | A | 0.016 | A | 15 | A |
| | 8-11 | 120 | A | 1.11 | B | A | 0.016 | A | 15 | A |

### Comparative Examples 8-1 to 8-8

In Comparative Examples 8-1 to 8-8, the inks were prepared using the same method as in Examples 8-1 to 8-11 to achieve the compositions shown in Tables 45 to 47. In Comparative Examples 8-1 to 8-8, the pigment dispersion with the crosslinking rate of 40% for the specific resin was used in each case. The ink of Comparative Example 8-1 differs from the inks of Examples 8-1 to 8-11 in that it does not contain the permeating agent c. The ink of Comparative Example 8-2 differs from the inks of Examples 8-1 to 8-11 in that the content of the permeating agent c is more than 10 mass %. The ink of Comparative Example 8-3 differs from the inks of Examples 8-1 to 8-11 in that the content of the wetting agent b is less than 7 mass %. The ink of Comparative Example 8-4 differs from the inks of Examples 8-1 to 8-11 in that it contains more than 15 mass % of the wetting agent b. The ink of Comparative Example 8-5 differs from the inks of Examples 8-1 to 8-11 in that it does not contain the solid additive d. The ink of Comparative Example 8-6 differs from the inks of Examples 8-1 to 8-11 in that the content of the solid additive d is more than 15 mass %. The ink of Comparative Example 8-7 differs from the inks of Examples 8-1 to 8-11 in that the average molecular weight of polyethylene glycol is more than 650. The ink of Comparative Example 8-8 differs from the inks of Examples 8-1 to 8-11 in that diethylene glycol (average molecular weight: 106.12) was used instead of the wetting agent b.

TABLE 45

| | | Component (mass %) | | | | | | | | Cross- |
|---|---|---|---|---|---|---|---|---|---|---|
| | | | | Cross- | | | | | | linking |
| | | Pig- | | linking | PEG | | ε-capro- | Sur- | | rate of |
| | | ment | Resin | agent | 400 | BTG | lactam | factant | Water | resin |
| Com- | 8-1 | 5 | 2 | 0.20 | 20 | — | 10 | 0.5 | Re- | 40% |
| par- | | | | | | | | | mainder | |
| ative | 8-2 | 5 | 2 | 0.20 | 7 | 15 | 3 | 0.5 | Re- | 40% |
| ex- | | | | | | | | | mainder | |
| ample | 8-3 | 5 | 2 | 0.20 | 5 | 3 | 10 | 0.5 | Re- | 40% |
| | | | | | | | | | mainder | |
| | 8-4 | 5 | 2 | 0.20 | 25 | 3 | 10 | 0.5 | Re- | 40% |
| | | | | | | | | | mainder | |
| | 8-5 | 5 | 2 | 0.20 | 12 | 3 | — | 0.5 | Re- | 40% |
| | | | | | | | | | mainder | |
| | 8-6 | 5 | 2 | 0.20 | 12 | 3 | 20 | 0.5 | Re- | 40% |
| | | | | | | | | | mainder | |

TABLE 46

| | | Component (mass %) | | | | | | | | Cross- |
|---|---|---|---|---|---|---|---|---|---|---|
| | | | | Cross- | | | | | | linking |
| | | Pig- | | linking | PEG | | ε-capro- | Sur- | | rate of |
| | | ment | Resin | agent | 1000 | BTG | lactam | factant | Water | resin |
| Com- | 8-7 | 5 | 2 | 0.20 | 12 | 3 | 10 | 0.5 | Re- | 40% |
| par- | | | | | | | | | mainder | |
| ative | | | | | | | | | | |
| ex- | | | | | | | | | | |
| ample | | | | | | | | | | |

TABLE 47

| | | Component (mass %) | | | | | | | | Cross- |
|---|---|---|---|---|---|---|---|---|---|---|
| | | | | Cross- | | | | | | linking |
| | | Pig- | | linking | | | ε-capro- | Sur- | | rate of |
| | | ment | Resin | agent | DEG | BTG | lactam | factant | Water | resin |
| Com- | 8-8 | 5 | 2 | 0.20 | 12 | 3 | 10 | 0.5 | Re- | 40% |
| par- | | | | | | | | | mainder | |
| ative | | | | | | | | | | |
| ex- | | | | | | | | | | |
| ample | | | | | | | | | | |

The inks of Comparative Examples 8-1 to 8-8 were evaluated for the intermittent ejection performance, the image density, the redispersibility, and the resistance to offset and curling occurrences. Table 48 shows the evaluation results for the intermittent ejection performance, the image density, the redispersibility, and the resistance to offset and curling occurrences for the inks of Comparative Examples 8-1 to 8-8. The ink of Comparative Example 8-1, which did not contain the permeating agent c, failed the evaluation for the resistance to offset occurrence. The ink of Comparative Example 8-2, which contained more than 10 mass % of the permeating agent c, failed the evaluation for the redispersibility. The ink of Comparative Example 8-3, which contained less than 7 mass % of the wetting agent b, failed the evaluation for the resistance to curling occurrence. The ink of Comparative Example 8-4, which contained more than 15 mass % of the wetting agent b, failed the evaluation for the resistance to offset occurrence. The ink of Comparative Example 8-5, which did not contain the solid additive d, failed the evaluation for the resistance to offset occurrence. The ink of Comparative Example 8-6, which contained more than 15 mass % of the solid additive d, failed the evaluation for the intermittent ejection performance. The ink of Comparative Example 8-7, where the average molecular weight of polyethylene glycol was more than 650, failed the evaluation for the intermittent ejection performance. The ink of Comparative Example 8-8, where diethylene glycol was used instead of the wetting agent b, failed the evaluation for the resistance to curling occurrence.

TABLE 48

| | | Evaluation results | | | | | | | | |
|---|---|---|---|---|---|---|---|---|---|---|
| | | Intermittent | | | | | | | | |
| | | ejection | | | | | Offset | | Curl | |
| | | performance | | Image density | | | Evalu- | | Evalu- | |
| | | Evalu- | | Evalu- | | Redisper- | ation | | ation | |
| | | ation | Evalu- | ation | Evalu- | sibility | value | Evalu- | value | Evalu- |
| | | value | ation | value | ation | Evaluation | (%) | ation | (mm) | ation |
| Comparative | 8-1 | 115 | A | 1.12 | B | A | 0.031 | B | 6 | A |
| example | 8-2 | 100 | B | 1.22 | A | B | 0.023 | A | 17 | A |
| | 8-3 | 105 | B | 1.19 | A | A | 0.015 | A | 22 | B |
| | 8-4 | 135 | A | 1.16 | A | A | 0.033 | B | 4 | A |
| | 8-5 | 130 | A | 1.18 | A | A | 0.031 | B | 19 | A |
| | 8-6 | 95 | C | 1.18 | A | A | 0.011 | A | 12 | A |
| | 8-7 | 90 | C | 1.19 | A | A | 0.015 | A | 14 | A |
| | 8-8 | 120 | A | 1.17 | A | A | 0.017 | A | 23 | B |

It should be understood by those skilled in the art that various modifications, combinations, sub-combinations and alterations may occur depending on design requirements and other factors insofar as they are within the scope of the appended claims or the equivalents thereof.

What is claimed is:

1. An aqueous ink for inkjet recording, comprising:
a pigment;
a polyethylene glycol having a number average molecular weight of 150 or more and 650 or less in an amount of 7 mass % or more and 20 mass % or less;
at least one selected from the group consisting of triethylene glycol monobutyl ether, 1,2-hexanediol, 1,2-octanediol, 2-methyl-2,4-pentanediol, dipropylene glycol monomethyl ether, and tripropylene glycol monomethyl ether in amount of 1 mass % or more and 10 mass % or less;
a water-soluble organic additive that is solid at 25° C. in an amount of 3 mass % or more and 15 mass % or less; and
water.

2. The aqueous ink for inkjet recording according to claim 1, further comprising a pigment dispersion resin.

3. The aqueous ink for inkjet recording according to claim 2, wherein the pigment dispersion resin is crosslinked on a surface of the pigment to form a specific resin.

4. The aqueous ink for inkjet recording according to claim 3, wherein a crosslinking rate of the specific resin is 25% or more and 90% or less.

5. The aqueous ink for inkjet recording according to claim 1, further comprising an acetylene glycol surfactant.

6. The aqueous ink for inkjet recording according to claim 1, having a dynamic surface tension of 40 mN/m or less at a surface lifetime of 10 milliseconds.

7. The aqueous ink for inkjet recording according to claim 1, having viscosity at 25° C. of 5.0 mPa·s or less.
